(19) United States
(12) Patent Application Publication
(10) Pub. No.: US 2025/0216514 A1
(43) Pub. Date: Jul. 3, 2025

(54) LIGHT-EMITTING MODULE, IMAGING DEVICE, AND IRRADIATION METHOD USING LIGHT-EMITTING MODULE

(71) Applicant: NICHIA CORPORATION, Anan-shi, Tokushima (JP)

(72) Inventors: Yoshinori SHINOHARA, Chino-shi (JP); Daiki NAGANAWA, Okaya-shi (JP); Naoki NAKAMURA, Suwa-gun (JP)

(73) Assignee: NICHIA CORPORATION, Anan-shi, Tokushima (JP)

(21) Appl. No.: 18/851,506

(22) PCT Filed: Mar. 20, 2023
(86) PCT No.: PCT/JP2023/010973

§ 371 Date: Sep. 26, 2024

(30) Foreign Application Priority Data
Mar. 30, 2022 (JP) 2022-054905
Sep. 22, 2022 (JP) 2022-151309

(51) Int. Cl. G01S 7/481; G01S 7/4863; G01S 7/4865; G01S 17/58; G01S 17/89; H05B 45/12; H05B 47/16

(52) U.S. Cl. CPC G01S 7/4814; G01S 7/4863; G01S 7/4865; G01S 17/58; G01S 17/89; H05B 45/12; H05B 47/16

(57) ABSTRACT

A light-emitting module includes: a light source including a plurality of light-emitting elements; a controller configured to individually turn on the plurality of light-emitting elements; a lens configured to transmit light from the plurality of light-emitting elements; and a driver configured to cause a relative rotation between the lens and the light source such that an optical axis of the lens or a central axis of the light source moves on a first trajectory in a top view. Light from each of the plurality of light-emitting elements after being transmitted through the lens is emitted such that a main light beam of the light moves on a second trajectory corresponding to the first trajectory.

### TECHNICAL FIELD

The present disclosure relates to a light-emitting module, an imaging device, and an irradiation method using the light-emitting module.

### BACKGROUND ART

Conventionally, light-emitting modules including a light source that includes light emitting diodes or the like and a lens that transmits light from the light source have been widely used. For example, Patent Document 1 discloses a light-emitting module that adjusts a function of a light distribution pattern by changing one or both of the shapes and the positions of a plurality of light distribution patterns.

### RELATED-ART DOCUMENTS

### PATENT DOCUMENTS

Patent Document 1: Japanese Patent Publication No. 2021-525680

### SUMMARY

A light-emitting module is required to have high spatial resolution of irradiation light. For example, a light-emitting module having high spatial resolution of irradiation light can emit light along the contour of an object to be irradiated with the light.

It is an object of an embodiment of the present disclosure to provide a light-emitting module having high spatial resolution of irradiation light, an imaging device, and an irradiation method using the light-emitting module.

A light-emitting module according to one embodiment of the present disclosure includes a light source including a plurality of light-emitting elements; a controller configured to individually turn on the plurality of light-emitting elements; a lens configured to transmit light from the plurality of light-emitting elements; and a driver configured to make a relative rotation between the lens and the light source such that an optical axis of the lens or a central axis of the light source moves on a first trajectory in a top view. Light from each of the plurality of light-emitting elements after being transmitted through the lens is emitted such that a main light beam of the light moves on a second trajectory corresponding to the first trajectory. The controller is configured to change brightness of the light from each of the plurality of light-emitting elements in a plurality of divided time periods obtained by dividing one cycle, where the one cycle is defined as one round of the main light beam of the light on the second trajectory.

A light-emitting module according to one embodiment of the present disclosure includes a light source including a plurality of light-emitting elements; a controller configured to individually turn on the plurality of light-emitting elements; a lens configured to transmit light from the plurality of light-emitting elements; and a driver configured to drive the lens and the light source relative to each other such that an optical axis of the lens or a central axis of the light source moves on a first trajectory in a top view. Light from each of the plurality of light-emitting elements after being transmitted through the lens is emitted such that a main light beam of the light moves on a second trajectory corresponding to the first trajectory. The controller is configured to change brightness of the light from each of the plurality of light-emitting elements in a plurality of divided time periods obtained by dividing one cycle, where the one cycle is defined as one round of the main light beam of the light on the second trajectory. The controller changes the brightness of the light from each of the plurality of light-emitting elements, based on object information acquired at each of a plurality of detection points on the second trajectory.

According to an embodiment of the present disclosure, a light-emitting module having high spatial resolution of irradiation light, an imaging device, and an irradiation method using the light-emitting module can be provided.

### BRIEF DESCRIPTION OF THE DRAWINGS

FIG. 1 is a diagram illustrating objects to be irradiated with light;

FIG. 2 is a diagram illustrating a reference example of irradiation light to the objects;

FIG. 3 is a diagram illustrating irradiation light by a light-emitting module according to an embodiment;

FIG. 4 is a block diagram illustrating a configuration of a smartphone in which an imaging device including a light-emitting module according to an embodiment is installed;

FIG. 5 is a cross-sectional view illustrating a configuration of the light-emitting module according to a first embodiment;

FIG. 6 is a plan view of a light source of the light-emitting module as viewed from the lens side;

FIG. 7 is a cross-sectional view taken through the line VII-VII of FIG. 6;

FIG. 8 is a cross-sectional view illustrating a configuration of another light-emitting part;

FIG. 9 is a block diagram illustrating a hardware configuration of the light-emitting module according to the first embodiment;

FIG. 10 is a block diagram illustrating a functional configuration of a controller according to the first embodiment;

FIG. 11 is a cross-sectional view illustrating the movement of the lens of the light-emitting module according to the first embodiment;

FIG. 12 is a top view of a first trajectory in FIG. 11;

FIG. 13 is a top view of a second trajectory in FIG. 11;

FIG. 14 is a diagram illustrating a distance image output from a LiDAR device;

FIG. 15 is a diagram illustrating a method of acquiring distance information from the distance image of FIG. 14;

FIG. 16 is a diagram illustrating the relationship between a distance image and a second trajectory;

FIG. 17 is a diagram illustrating an example of the relationship between an object distance and the brightness of irradiation light to an object;

FIG. 18 is a diagram illustrating a first example of a change in the brightness of the irradiation light according to the object distance;

FIG. 19 is a diagram illustrating a second example of a change in the brightness of the irradiation light according to the object distance;

FIG. 20 is a diagram illustrating an example of divided time periods according to the embodiment;

FIG. 21 is a timing chart illustrating an example of an irradiation operation by the light-emitting module according to the embodiment;

FIG. 22 is a flowchart illustrating an irradiation process performed by the controller according to the embodiment;

FIG. 23 is a first diagram illustrating irradiation light in a divided time period according to the embodiment;

FIG. 24 is a second diagram illustrating irradiation light in a divided time period according to the embodiment;

FIG. 25 is a third diagram illustrating irradiation light in a divided time period according to the embodiment;

FIG. 26 is a fourth diagram illustrating irradiation light in a divided time period according to the embodiment;

FIG. 27 is a contour diagram illustrating an illuminance distribution of irradiation light according to the embodiment;

FIG. 28 is a diagram illustrating a cross-sectional illuminance distribution taken through the line XXVIII-XXVIII of FIG. 27;

FIG. 29A is a diagram illustrating an evaluation chart, used in quantitative evaluation of the amounts of deviation of irradiation light patterns from the contours of objects;

FIG. 29B is a diagram illustrating a conventional irradiation light image, obtained in the quantitative evaluation of the amounts of deviation of the irradiation light patterns from the contours of the objects;

FIG. 29C is a diagram illustrating a difference image between the images of FIG. 29A and FIG. 29B, obtained in the quantitative evaluation of the amounts of deviation of the irradiation light patterns from the contours of the objects;

FIG. 29D is a diagram illustrating an irradiation light image according to the embodiment, obtained in the quantitative evaluation of the amounts of deviation of the irradiation light patterns from the contours of the objects;

FIG. 29E is a diagram illustrating a difference image between the images of FIG. 29A and FIG. 29D, obtained in the quantitative evaluation of the amounts of deviation of the irradiation light patterns from the contours of the objects;

FIG. 30 is a diagram illustrating an example of quantitative evaluation results of the amounts of deviation of the irradiation light patterns from the contours of the objects.

FIG. 31 is a contour diagram illustrating a reduction in illuminance at the outer edge of irradiation light;

FIG. 32 is a cross-sectional view illustrating a configuration of a light source including a first light source and a second light source;

FIG. 33A is a diagram illustrating a first trajectory having a rectangular shape according to a modification of the embodiment;

FIG. 33B is a diagram illustrating a first trajectory having an elliptical shape according to a modification of the embodiment;

FIG. 34 is a top view illustrating a configuration of a light-emitting module according to a second embodiment;

FIG. 35 is a cross-sectional view taken through the line XXXV-XXXV of FIG. 34;

FIG. 36 is a plan view of a light-emitting-part mounting substrate of the light-emitting module of FIG. 34 as viewed from the lens side;

FIG. 37A is a plan view of a movable part of the light-emitting module of FIG. 34 as viewed from the light source side;

FIG. 37B is a diagram illustrating a preferred configuration of a rolling body and a movement restriction member included in the light-emitting module of FIG. 34;

FIG. 38 is a block diagram illustrating an example hardware configuration of the light-emitting module according to the second embodiment;

FIG. 39 is a block diagram illustrating an example of a functional configuration of a controller according to the second embodiment;

FIG. 40 is a cross-sectional view illustrating an example of the movement of a lens of the light-emitting module according to the second embodiment;

FIG. 41A is a schematic diagram illustrating an example of stop control performed by the controller according to the second embodiment;

FIG. 41B is a schematic diagram illustrating an example of movement control in the −X direction performed by the controller according to the second embodiment;

FIG. 41C is a schematic diagram illustrating an example of movement control in the +X direction performed by the controller according to the second embodiment;

FIG. 42 is a cross-sectional view illustrating a configuration of a light-emitting module according to a third embodiment;

FIG. 43 is a cross-sectional view illustrating an example of the movement of a movable part of the light-emitting module according to the third embodiment;

FIG. 44A is a schematic diagram illustrating an example of stop control performed by a controller according to the third embodiment;

FIG. 44B is a schematic diagram illustrating an example of movement control in the −X direction performed by the controller according to the third embodiment; and

FIG. 44C is a schematic diagram illustrating an example of movement control in the +X direction performed by the controller according to the third embodiment.

### DETAILED DESCRIPTION

A light-emitting module, an imaging device, and an irradiation method using the light-emitting module according to embodiments of the present disclosure will be described in detail below with reference to the accompanying drawings. The embodiments described below exemplify the light-emitting module, the imaging device, and the irradiation method using the light-emitting module to give a concrete form to the technical ideas of the present disclosure, and the scope of the disclosure is not limited to the embodiments described below. In addition, unless otherwise specified, the dimensions, materials, shapes, relative arrangements, and the like of components described in the embodiments are not intended to limit the scope of the present disclosure thereto, but are described as examples. The sizes, positional relationships, and the like of members illustrated in the drawings may be exaggerated for clearer illustration. Further, in the following description, the same names and reference numerals denote the same or similar members, and a detailed description thereof will be omitted as appropriate. An end view illustrating only a cut surface may be used as a cross-sectional view.

In the drawings, directions may be indicated by an X-axis, a Y-axis, and a Z-axis. An X direction along the X-axis indicates a predetermined direction along a light-emitting surface of a light source of the light-emitting module according to the embodiments. A Y direction along the Y-axis indicates a direction orthogonal to the X direction along the light-emitting surface. A Z direction along the Z-axis indicates a direction orthogonal to the light-emitting surface. That is, the light-emitting surface of the light source is parallel to the XY plane, and the Z-axis is orthogonal to the XY plane.

Further, a direction indicated by an arrow in the X direction is referred to as a +X direction or a +X side, and a direction opposite to the +X direction is referred to as a −X direction or a −X side. A direction indicated by an arrow in the Y direction is referred to as a +Y direction or a +Y side, and a direction opposite to the +Y direction is referred to as a −Y direction or a −Y side. A direction indicated by an arrow in the Z direction is referred to as a +Z direction or a +Z side, and a direction opposite to the +Z direction is referred to as a −Z direction or a −Z side. In the embodiments, the light source of the light-emitting module is configured to emit light to the +Z side as an example. Further, the expression “in a top view” as used in the embodiments refers to viewing an object from the +Z side. However, this does not limit the orientation of the light-emitting module during use, and the orientation of the light-emitting module is discretionary. Further, in the embodiments described below, “along an axis” includes a case in which an object is at an inclination within a range of ±10° with respect to the axis. In addition, a “substantially rectangular shape” may be expressed as a “rectangular shape”. The “substantially rectangular shape” means a shape with a deviation from a rectangular shape, such as a rectangle shape having a chipped portion or a rectangle shape in which a recess or a projection is formed in a portion of the sides.

### EMBODIMENTS

A light-emitting module according to an embodiment includes a light source including a plurality of light-emitting elements; a controller configured to individually turn on the plurality of light-emitting elements; and a lens configured to transmit light from the plurality of light-emitting elements. The light-emitting module can selectively emit light from the plurality of light-emitting elements. The light-emitting module is installed in an imaging device such as a digital camera, for example, and is used as a flash light source that irradiates an object with light when the imaging device captures an image of the object.

There may be a case in which the light-emitting module described above may emit light obtained by reducing the brightness of a portion of the light transmitted through a lens. For example, it is assumed that a person or the like, which is an object, is located close to the imaging device and a background such as scenery around the person is located far from the imaging device. In such a case, if the entire irradiation region is irradiated with light having the same brightness from the light-emitting module of the imaging device, the brightness of the light beams emitted to the object becomes excessive, and abnormalities such as overexposure may occur in an image captured by the imaging device. The “overexposure” refers to a state of an captured image in which the gradation of a bright portion is lost and the bright portion is completely white. In order to prevent such an abnormality, the light-emitting module emits light obtained by reducing the brightness of a portion of the light.

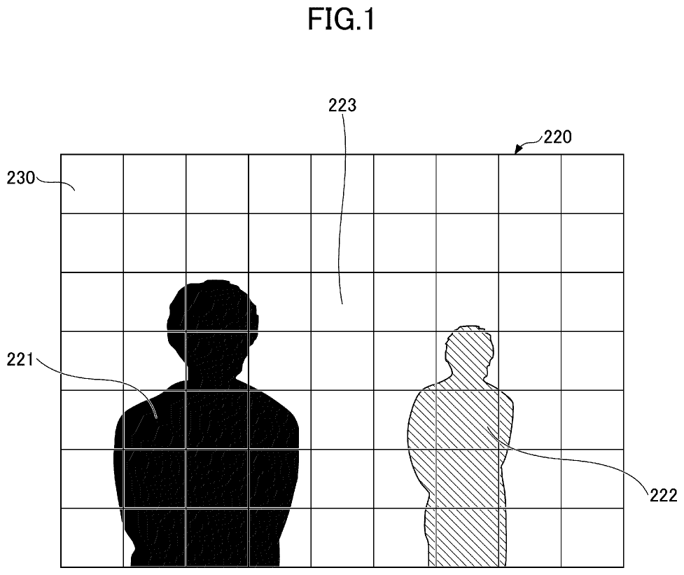

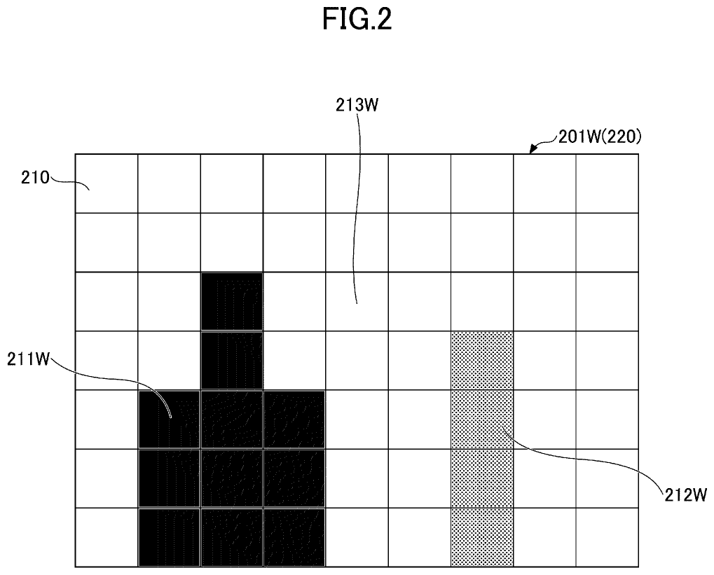

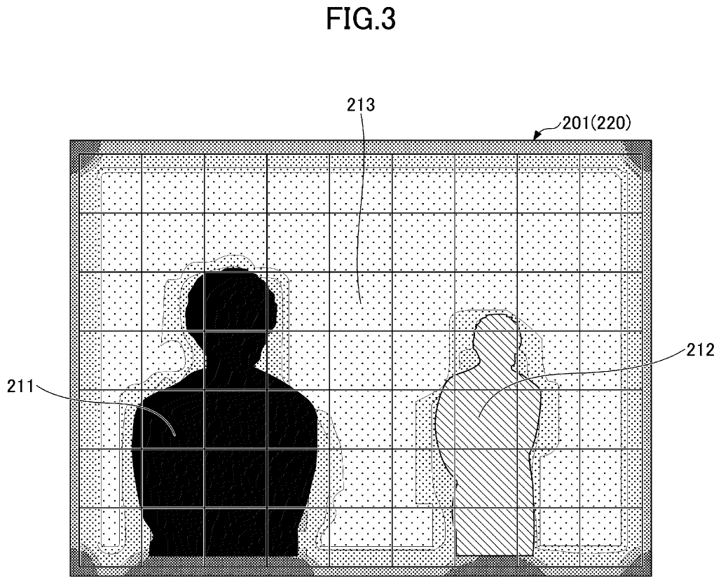

FIG. 1 to FIG. 3 are each a diagram illustrating irradiation light obtained by reducing the brightness of a portion of the light transmitted through a lens. FIG. 1 is a diagram illustrating objects to be irradiated with light. FIG. 2 is a diagram illustrating a reference example of irradiation light to the objects. FIG. 3 is a diagram illustrating irradiation light by a light-emitting module according to an embodiment.

In FIG. 1, an irradiation region 220 is a region to which the light-emitting module can emit light. A plurality of rectangular individual regions 230 included in the irradiation region 220 are regions to which a plurality of light-emitting elements included in the light-emitting module can individually emit light. The irradiation region 220 includes a first object 221, a second object 222, and a background 223. Each of the first object 221 and the second object 222 is a person. In FIG. 1, the first object 221 is located closer to an imaging device than the second object 222 is, and the second object 222 is located closer to the imaging device than the background 223 is.

Irradiation light 201W is light with which the irradiation region 220 is irradiated. Thus, in FIG. 2, the reference numeral of the irradiation region 220 is indicated in parentheses together with the reference numeral of the irradiation light 201W. A plurality of individual lights 210 included in the irradiation light 201W are individual irradiation lights from the plurality of light-emitting elements included in the light-emitting module. First object irradiation light 211W is light with which the first object 221 is irradiated. Second object irradiation light 212W is light with which the second object 222 is irradiated. Background irradiation light 213W is light with which the background 223 is irradiated. Each of the first object irradiation light 211W, the second object irradiation light 212W, and the background irradiation light 213W is constituted by a plurality of individual lights 210.

In order to suppress abnormalities such as overexposure, as the distance to an object to be irradiated with irradiation light decreases, the brightness of the irradiation light becomes preferably lower. Therefore, the brightness of the second object irradiation light 212W is lower than the brightness of the background irradiation light 213W according to the distances to the objects. The brightness of the first object irradiation light 211W is lower than the brightness of second object irradiation light 212W according to the distances to the objects.

When the irradiation light to the objects is generated by changing the brightness of each of the individual lights 210, the spatial resolution of the irradiation light 201W is determined by the size of each of the individual lights 210, in other words, by the size of each of the individual regions 230. In such a case, as illustrated in FIG. 2, there would be a case in which the irradiation light 201W having an irradiation light pattern along the contours of the first object 221 and the second object 222 cannot be emitted.

Conversely, in FIG. 3, irradiation light 201 is an example of irradiation light by the light-emitting module according to the embodiment. The irradiation light 201 is light to be emitted to the irradiation region 220. Thus, the reference numeral of the irradiation region 220 is indicated in parentheses together with the reference numeral of the irradiation light 201 in FIG. 3. First object irradiation light 211 is light with which the first object 221 is irradiated. Second object irradiation light 212 is light with which the second object 222 is irradiated. Background irradiation light 213 is light with which the background 223 is irradiated. Each of the first object irradiation light 211, the second object irradiation light 212, and the background irradiation light 213 is constituted by a plurality of individual lights 210. As compared to FIG. 2, the first object irradiation light 211 can be emitted along the contour of the first object 221, and the second object irradiation light 212 can be emitted along the contour of the second object 222. The relationship between the distances to the objects and the brightness of the first object irradiation light 211, the second object irradiation light 212, and the background irradiation light 213 is the same as that described in FIG. 1.

In the present embodiment, the irradiation light 201 is obtained by overlap of irradiation lights by making a relative rotation between a lens and a light source such that the optical axis of the lens or the center of the light source moves on a first trajectory in a top view. Each of regions irradiated with individual lights 210 can be further divided based on brightness produced by overlap. Accordingly, the spatial resolution of the irradiation light 201 is increased, and the irradiation light 201 having resolution patterns higher than patterns of the irradiation light 201W of FIG. 2 can be obtained. As illustrated in FIG. 3, the irradiation light 201 having irradiation light patterns along the contours of the first object 221 and the second object 222 can be emitted. In the following, the configurations, functions, operations, and the like of a light-emitting module, an imaging device including the light-emitting module, and an irradiation method using the light-emitting module according to an embodiment will be described in detail.

### First Embodiment

### Example Configuration of Imaging Device 300

### (Overall Configuration)

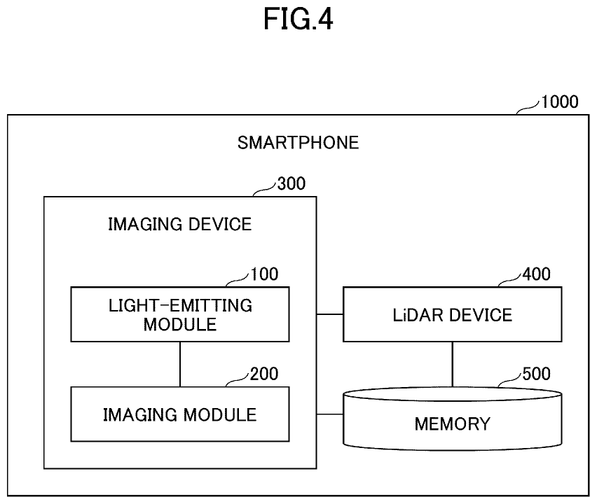

FIG. 4 is a block diagram illustrating a configuration of a smartphone 1000 in which an imaging device 300 including a light-emitting module 100 according to a first embodiment is installed. The smartphone 1000 includes the imaging device 300, a light detection and ranging (LiDAR) device 400, and a memory 500. The LiDAR device 400 is an example of an object acquisition device that acquires object information.

The imaging device 300 includes the light-emitting module 100 and an imaging module 200. The imaging device 300 can output an image captured by the imaging module 200 to the memory 500, a display of the smartphone 1000, or the like.

The light-emitting module 100 is used as a flash light source that irradiates an object with light when the imaging device 300 captures an image. The light-emitting module 100 can receive, from the imaging module 200, a turn-on signal including turn-on timing information of a plurality of light-emitting elements, and irradiate an object with light based on the turn-on signal.

The imaging module 200 includes an imaging lens and an imaging element such as a charge-coupled device (CCD) or a complementary metal oxide semiconductor (CMOS). The imaging module 200 causes the imaging element to capture an object image substantially formed by the imaging lens.

The LiDAR device 400 is a device that can measure the distance between the smartphone 1000 and an object such as a subject. The LiDAR device 400 outputs a distance image measured by, for example, a time of flight (TOF) method to the imaging device 300 or the like. The TOF method is a method of measuring a distance by using the time of flight of light. The distance image is an image in which pixels representing distance information are arranged one-dimensionally or two-dimensionally. In the present embodiment, the LiDAR device 400 can output a two-dimensional distance image to the imaging device 300 or the like.

The memory 500 can store various kinds of information. The memory 500 includes a volatile random-access memory (RAN), a non-volatile read-only memory (ROM), an SD card or a micro SD card, which is an external storage medium, and the like. In the present embodiment, the memory 500 can store images captured by the imaging device 300, distance images obtained by the LiDAR device 400, and the like.

### (Configuration of Light-Emitting Module 100)

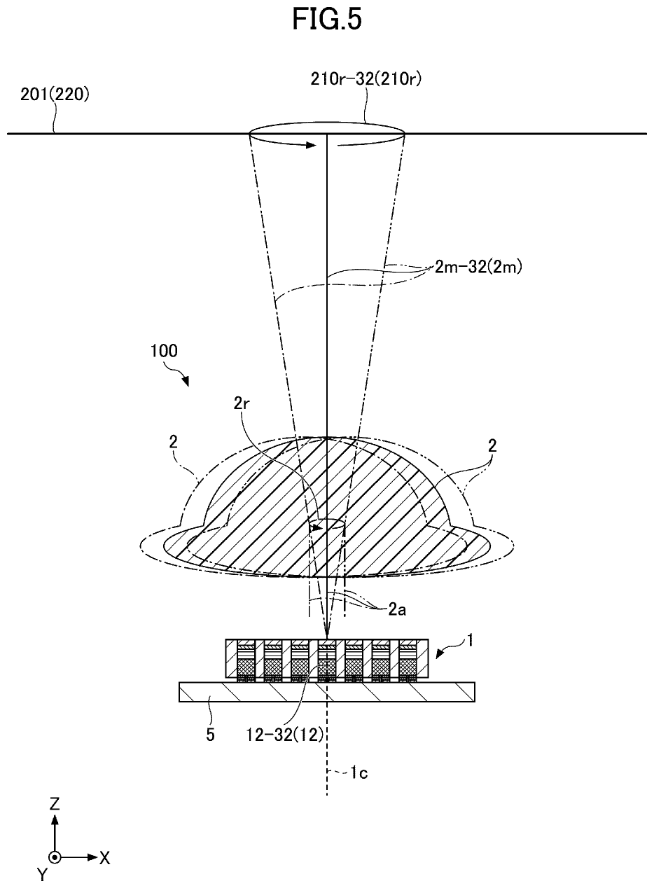

FIG. 5 is a cross-sectional view illustrating a configuration of the light-emitting module 100. The light-emitting module 100 includes a light source 1 and a lens 2. The light source 1 is mounted on the upper surface (the surface on the +Z side) of a light-emitting-part mounting substrate 5. In FIG. 5, the lens 2 is supported with a support member such as a housing above the light source 1, in a drivable manner, such that the lens 2 overlaps the light source 1 in a top view. The light-emitting-part mounting substrate 5 is a plate-shaped member having a rectangular shape in a top view, and is a substrate that includes wiring and on which light-emitting elements and various electrical elements can be mounted. Note that the lens 2 is not necessarily located above the light source 1. If the lens 2 is not located above the light source 1, light may be incident on the lens 2 by using a reflector or the like to reflect the light. For example, the reflector is disposed at a position toward which light travels from the light source 1, to reflect the emitted light, and the lens is disposed at a position toward which the reflected light by the reflector travels. As an example, the reflector is disposed above the light source 1, and light from the light source 1 is reflected by the reflector in a first direction (for example, a horizontal direction) and is incident on the lens 2 disposed in the first direction.

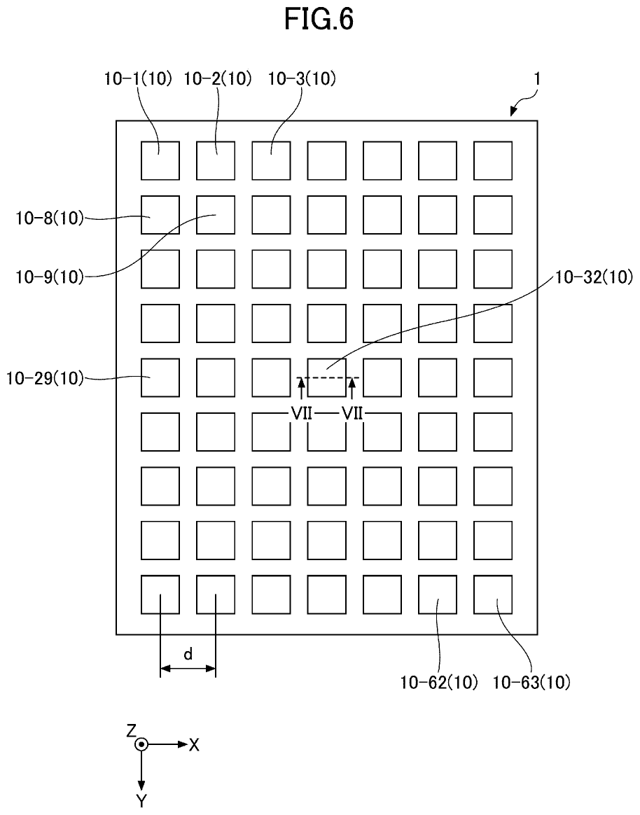

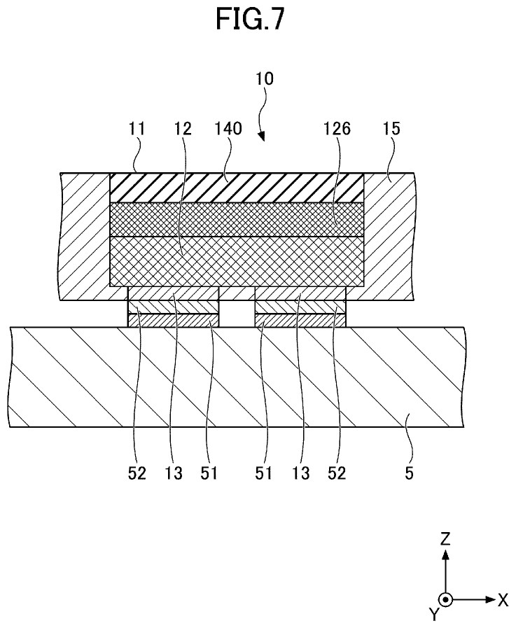

The light source 1 includes a plurality of light-emitting elements 12. The plurality of light-emitting elements 12 emit light toward the lens 2 provided above (on the +Z side of) the light source 1. A light-emitting element 12-32 in FIG. 5 is the thirty-second light emitting element among the plurality of light emitting elements 12. In the light source 1 according to the present embodiment, the light-emitting element 12-32 is a light-emitting element located at the center of the light source 1. A detailed configuration of the plurality of light emitting elements 12 will be described later with reference to FIG. 6 and FIG. 7.

The lens 2 transmits the light from the plurality of light-emitting elements 12. The lens 2 includes at least one of a resin material, such as a polycarbonate resin, an acrylic resin, a silicone resin, or an epoxy resin, or a glass material. The lens 2 preferably has an optically transmissive property that allows 60% or more of the light from the plurality of light-emitting elements 12 to be transmitted. In the present embodiment, the lens 2 constituted by one refractive lens is exemplified. The lens 2 may include a plurality of lenses, may include a Fresnel lens or a diffraction lens, or may include a lens including a reflective portion such as a total internal reflection (TIR) lens.

In the present embodiment, the lens 2 is rotatable such that an optical axis 2a of the lens 2 moves on a first trajectory 2r in a top view. In other words, when the optical axis 2a of the lens 2 coincides with a central axis 1c of the light source 1, the lens 2 is rotatable about the central axis 1c of the light source 1. In the present embodiment, the first trajectory 2r has a circular shape. Note that the central axis 1c of the light source 1 is an axis passing through the center of the light source 1 and is parallel to the optical axis 2a. Further, the “center of the light source” is the geometric centroid of the light source 1. For example, if the light source 1 has a rectangular shape in a top view, the center of the light source 1 is an intersection of the diagonal lines of the light source 1.

In FIG. 5, the lens 2 indicated by a solid line is not displaced in the X direction. The lens 2 indicated by a dash-dot line is displaced to the −X side by rotation. The lens 2 indicated by a two-dot dash line is displaced to the +X side by rotation. The position of the optical axis 2a of the lens 2 is also displaced in accordance with the displacement of the lens 2. The optical axis 2a indicated by a solid line is the optical axis of the lens 2 that is not displaced in the X direction. The optical axis 2a indicated by a dash-dot line is the optical axis of the lens 2 that is displaced to the −X side by rotation. The optical axis 2a indicated by a two-dot dash line is the optical axis of the lens 2 that is displaced to the +X side by rotation. Note that the lens 2 and the optical axis 2a may be displaced in the Y direction, or may be displaced in both the X direction and the Y direction.

Light from the light-emitting elements 12 after being transmitted through the lens 2 is emitted to the irradiation region 220 as irradiation light 201. Further, light from each of the light-emitting elements 12 after being transmitted through the lens 2 is emitted such that a main light beam 2m of the light moves on a second trajectory 210r, which corresponds to the first trajectory 2r, according to the rotation of the lens 2. Note that the main light beam 2m is a collective term for main light beams of the plurality of light-emitting elements 12. The second trajectory 210r is a collective term for second trajectories on which light from the plurality of light-emitting elements 12 moves.

The main light beam 2m is a light beam emitted from each of the light-emitting elements 12 and passing through the center of the lens 2. If the lens 2 includes an aperture diaphragm, the main light beam 2m corresponds to a light beam emitted from the light emitting element 12 and passing through the center of the aperture diaphragm of the lens 2. Further, images of the light emitting elements 12 are projected onto the irradiation region 220 through the lens 2, and thus the position of the main light beam 2m can also be identified from the center position of individual lights 210 corresponding to an irradiated image from each of the light-emitting elements 12 onto the irradiation region 220 through the lens 2.

FIG. 5 illustrates a state in which a main light beam 2m-32 of light from the light-emitting element 12-32 after being transmitted through the lens 2 moves on a second trajectory 210r-32. The first trajectory 2r has a circular shape, and thus the second trajectory 210r-32 also has a circular shape. The main light beam 2m indicated by a solid line is a main light beam transmitted through the lens 2 that is not displaced in the X direction. The main light beam 2m-32 indicated by a dash-dot line is a main light beam transmitted through the lens 2 that is displaced to the −X side by rotation. The main light beam 2m-32 indicated by a two-dot dash line is a main light beam transmitted through the lens 2 that is displaced to the +X side by rotation.

### (Configuration of Light Source 1)

A configuration of the light source 1 will be described with reference to FIG. 6 and FIG. 7. FIG. 6 is a plan view of the light source 1 as viewed from the lens 2 side. FIG. 7 is a cross-sectional view taken through the line VII-VII of FIG. 6.

As illustrated in FIG. 6, the light source 1 includes sixty-three light-emitting parts 10, from a light-emitting part 10-1 to a light-emitting part 10-63, arranged in the vertical direction and the lateral direction or arranged in a grid pattern in a top view. The plurality of light-emitting parts 10 are arranged along the X direction or arranged along the X direction and the Y direction. In FIG. 6, the plurality of light-emitting parts 10 are arranged along the X direction and the Y direction. A distance d indicated in FIG. 6 is a distance between the centers of adjacent light-emitting parts 10 among the plurality of light-emitting parts 10.

In FIG. 6, the sixty-three light-emitting parts 10 arranged in the vertical direction and the lateral direction or arranged in a grid pattern are depicted; however, the arrangement and the number of the light-emitting parts 10 are not limited thereto. The number of the light-emitting parts 10 may be at least two, and the arrangement and the number of the light-emitting parts 10 can be appropriately changed according to the use or the like of the light-emitting module 100.

### (Configuration of Light-Emitting Part 10)

As illustrated in FIG. 7, a light-emitting part 10 is mounted on the surface on the +Z side of the light-emitting-part mounting substrate 5, with the surface on the +Z side serving as a light-emitting surface 11 and the surface opposite the light-emitting surface 11 serving as a mounted surface. The light-emitting surface 11 refers to a main light extraction surface of the light-emitting part 10. As the light-emitting part 10, a light-emitting diode (LED) or the like can be used. Light emitted from the light-emitting part 10 is preferably white light. Light emitted from the light-emitting part 10 may be monochromatic light. By selecting the light-emitting part 10 according to the use of the light-emitting module 100, light emitted from the light-emitting part 10 can be appropriately selected.

The light-emitting part 10 includes a light-emitting element 12, a wavelength conversion member 126, a light diffusion member 140, and a covering member 15. The wavelength conversion member 126 is provided on (the +Z side of) the light-emitting element 12. The light diffusion member 140 is provided on (the +Z side of) the wavelength conversion member 126. The covering member 15 covers the lateral surfaces of each of the light-emitting element 12, the wavelength conversion member 126, and the light diffusion member 140. Light-emitting elements 12 are provided for respective light-emitting parts 10, and thus the distance d between the centers of adjacent light-emitting elements 12 can also be referred to as the distance between the centers of adjacent light-emitting elements 12. If a plurality of light-emitting elements 12 are provided for one light-emitting part 10, the distance d is defined as the distance between the geometric centers of adjacent light-emitting parts 10 in a top view. The distance d is, for example, 50 μm or more and 1,000 μm or less, preferably 100 μm or more and 600 μm or less, and more preferably 150 μm or more and 500 μm or less.

At least a pair of positive and negative electrodes 13 are preferably provided on the surface of the light-emitting element 12 opposite the light-emitting surface 11. In the present embodiment, the outer shape of the light-emitting surface 11 in a top view is a rectangular shape. The outer shape of the light-emitting surface 11 in a top view may be a substantially circular shape, a substantially elliptical shape, or a polygonal shape such as a substantially triangular shape or a substantially hexagonal shape.

The light-emitting element 12 is preferably made of various semiconductors such as group III-V compound semiconductors and group II-VI compound semiconductors. As the semiconductors, nitride-based semiconductors such as InₓAl_{y}Ga_{1-X-Y}N (0≤X, 0≤Y, X+Y≤1) are preferably used, and InN, AlN, GaN, InGaN, AlGaN, InGaAlN, and the like can also be used.

The wavelength conversion member 126 converts a wavelength of at least a portion of light from the light-emitting element 12. Examples of the wavelength conversion member 126 include a yttrium aluminum garnet based phosphor (for example, Y₃(Al, Ga)₅O₁₂:Ce), a lutetium aluminum garnet based phosphor (for example, Lu₃(Al, Ga)₅O₁₂:Ce), a terbium aluminum garnet based phosphor (for example, Tb₃(Al, Ga)₅O₁₂:Ce), a CCA based phosphor (for example, Ca₁₀(PO₄)₆C₁₂:Eu), an SAE based phosphor (for example, Sr₄Al₁₄O₂₅:Eu), a chlorosilicate based phosphor (for example, Ca_{B}MgSi₄O₁₆C₁₂:Eu), a nitride based phosphor, a fluoride based phosphor, a phosphor having a perovskite structure (for example, CsPb(F, Cl, Br, I)₃), a quantum dot phosphor (for example, CdSe, InP, AgInS₂, AgInSe₂, AgInGaS₂, or CuAgInS₂), and the like. Examples of the nitride based phosphor include a β-sialon based phosphor (for example, (Si, Al)₃(O, N)₄:Eu), an α-sialon based phosphor (for example, Ca(Si, Al)₁₂(O, N)1₆:Eu), an SLA based phosphor (for example, SrLiAl₃N₄:Eu), a CASN based phosphor (for example, CaAlSiN₃:Eu), a SCASN based phosphor (for example, (Sr, Ca)AlSiN₃:Eu), and the like. Examples of the fluoride based phosphor include a KSF based phosphor (for example, K₂SiF₆:Mn), a KSAF based phosphor (for example, K₂(Si, Al)F₆:Mn), an MGF based phosphor (for example, 3.5MgO·0.5MgF₂·GeO₂:Mn), and the like. The phosphors described above are particles. Further, one of these wavelength conversion members can be used alone, or two or more of these wavelength conversion members can be used in combination.

The KSAF based phosphor may have a composition represented by Formula (I) below.

M₂[SiₚAl_{q}MnᵣFₛ] (I)

In Formula (I), M represents an alkali metal and may include at least K. Mn may be a tetravalent Mn ion. p, q, r, and s may satisfy 0.9≤p+q+r≤1.1, 0<q≤0.1, 0<r≤0.2, 5.9≤s≤6.1. Preferably, p, q, r, and s may satisfy 0.95≤p+q+r≤1.05 or 0.97≤p+q+r≤1.03, 0<q≤0.03, 0.002≤q≤0.02, or 0.003≤q≤0.015, 0.005≤r≤0.15, 0.01≤r≤0.12, or 0.015≤r≤0.1, and 5.92≤s≤6.05 or 5.95≤s≤6.025. Examples of the composition represented by Formula (I) include compositions represented by K₂ [Si_{0.946}Al_{0.005}Mn_{0.049}F_{5.995}], K₂[Si_{0.942}Al_{0.008}Mn_{0.050}F_{5.992}], K₂[Si_{0.939}Al_{0.014}Mn_{0.047}F_{5.985}]. Such a KSAF based phosphor enables red light emission having a high luminance and a peak emission wavelength with a narrow full width at half maximum.

Examples of the wavelength conversion member 126 include a resin material, a ceramic, glass, or the like in which a wavelength conversion member as described above is contained; and a sintered body of a wavelength conversion member. Further, the wavelength conversion member 126 may be one in which a resin layer containing a wavelength conversion member is disposed on the upper surface (the surface on the ±Z side) of a formed body of a resin, a ceramic, glass, or the like.

In the embodiment, the light-emitting module 100 uses a blue light-emitting element as the light-emitting element 12, and allows the wavelength conversion member 126 to convert a wavelength of light emitted from the light-emitting element 12 into a wavelength of yellow light, thereby emitting white light.

The light diffusion member 140 diffuses the light transmitted through the wavelength conversion member 126. The light diffusion member 140 is a plate-shaped member having a rectangular shape in a top view. The light diffusion member 140 is provided so as to cover the surface on the +Z side of the wavelength conversion member 126. Examples of the light diffusion member 140 include titanium oxide, barium titanate, aluminum oxide, silicon oxide, and the like.

The covering member 15 is a member that covers the lateral surfaces of the light-emitting element 12, the lateral surfaces of the wavelength conversion member 126, and the lateral surfaces of the light diffusion member 140. The covering member 15 directly or indirectly covers the lateral surfaces of the light-emitting element 12, the lateral surfaces of the wavelength conversion member 126, and the lateral surfaces of the light diffusion member 140. The upper surface (the surface on the +Z side) of the light diffusion member 140 is exposed through the covering member 15, and serves as the light-emitting surface 11 of the light-emitting part 10. In the light-emitting module 100 according to the present embodiment, a portion of the covering member 15 is located between adjacent light-emitting parts 10, and contacts each of the adjacent light-emitting parts 10. The covering member 15 may be separated between the adjacent light-emitting parts 10.

In order to improve the light extraction efficiency, the covering member 15 is preferably composed of a member having a high light reflectance. For example, a resin material containing a light reflective substance such as a white pigment can be used for the covering member 15.

Examples of the light reflective substance include titanium oxide, zinc oxide, magnesium oxide, magnesium carbonate, magnesium hydroxide, calcium carbonate, calcium hydroxide, calcium silicate, magnesium silicate, barium titanate, barium sulfate, aluminum hydroxide, aluminum oxide, zirconium oxide, silicon oxide, and the like. It is preferable to use one of the above substances alone or a combination of two or more of the above substances.

Further, for the resin material, it is preferable to use, as a base material, a resin material whose main component is a thermosetting resin such as an epoxy resin, a modified epoxy resin, a silicone resin, a modified silicone resin, or a phenol resin. The covering member 15 may be configured with a light transmissive member that transmits visible light as necessary.

The light-emitting-part mounting substrate 5 preferably includes wiring 51 disposed on the surface thereof. Further, a portion of the wiring may be provided inside the light-emitting-part mounting substrate 5. The light-emitting-part mounting substrate 5 and the light-emitting part 10 are electrically connected to each other by connecting the wiring 51 of the light-emitting-part mounting substrate 5 to at least the pair of positive and negative electrodes 13 of the light-emitting part 10 via electrically-conductive adhesive members 52. The configuration, the size, and the like of the wiring 51 of the light-emitting-part mounting substrate 5 are set according to the configuration, the size, and the like of the electrodes 13 of the light-emitting part 10.

The light-emitting-part mounting substrate 5 preferably uses an insulating material as a base material. The light-emitting-part mounting substrate 5 preferably uses a material through which light emitted from the light-emitting part 10, external light, or the like is not easily transmitted and having a certain mechanical strength. Specifically, the light-emitting-part mounting substrate 5 can include, as a base material, a ceramic such as alumina, aluminum nitride, mullite, or silicon nitride, or a resin such as a phenol resin, an epoxy resin, a polyimide resin, a bismaleimide triazine resin (BT resin), or polyphthalamide.

The wiring 51 can be composed of at least one selected from the group consisting of copper, iron, nickel, tungsten, chromium, aluminum, silver, gold, titanium, palladium, rhodium, alloys thereof, and the like. In addition, a layer of silver, platinum, aluminum, rhodium, gold, an alloy thereof, or the like may be provided on the surface layer of the wiring 51 from the viewpoint of wettability and/or light reflectivity of the electrically-conductive adhesive members 52.

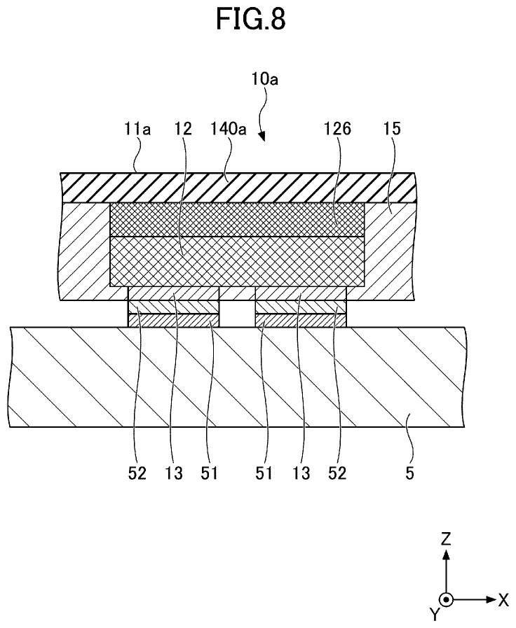

Further, the light-emitting module 100 can include a light-emitting part 10a illustrated in FIG. 8. FIG. 8 is a cross-sectional view illustrating a configuration of a light-emitting part 10a, which is an example of another light-emitting part. The light-emitting part 10a includes a light diffusion member 140a. The light diffusion member 140a covers the upper surface of a covering member 15. The covering member 15 covers the lateral surfaces of a light-emitting element 12 and the lateral surfaces of a wavelength conversion member 126.

The light diffusion member 140a is one member that diffuses light that has passed through wavelength conversion members 126 of a plurality of light-emitting parts 10a. A light-emitting surface 11a, which is the surface on the +Z side, of the light diffusion member 140a serves as one extraction surface through which light from each of the plurality of light-emitting parts 10a is extracted.

### (Hardware Configuration of Light-Emitting Module 100)

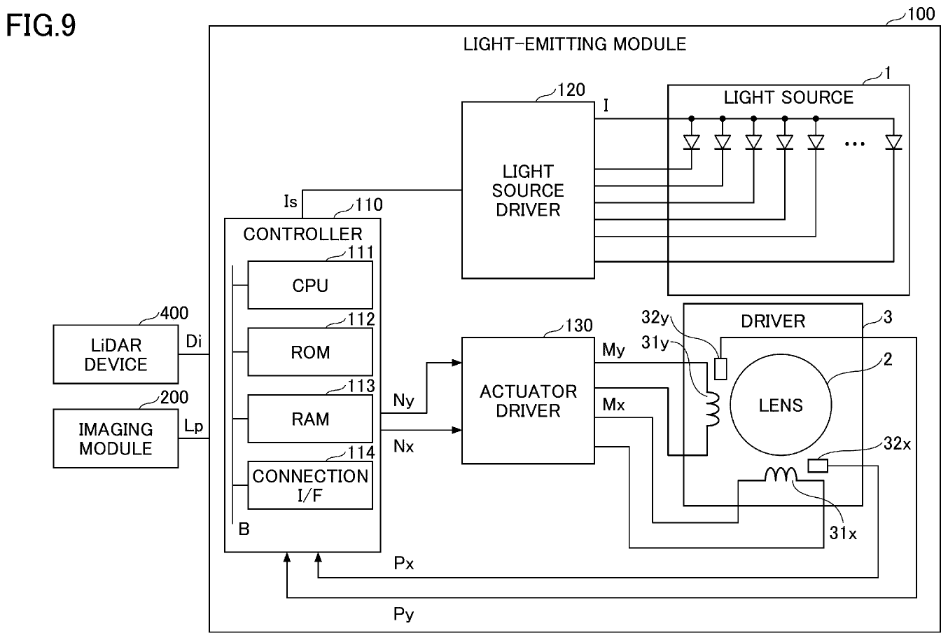

FIG. 9 is a block diagram illustrating an electrical hardware configuration of the light-emitting module 100. The light-emitting module 100 includes a controller 110, a light source driver 120, an actuator driver 130, and a driver 3. Further, the light-emitting module 100 receives object information from the LiDAR device 400 and a turn-on signal Lp from the imaging module 200.

The light source driver 120 is an electric circuit that can individually turn on light-emitting elements 12 included in a plurality of light-emitting parts 10 of the light source 1 by outputting a light source drive current I. The driver 3 can rotate the lens 2 such that the optical axis 2a of the lens 2 moves on the first trajectory 2r in a top view. The actuator driver 130 is an electric circuit that can drive the driver 3 by outputting a lens drive current Mx and a lens drive current My.

The driver 3 includes a coil 31x, a coil 31y, a position detection sensor 32x, and a position detection sensor 32y. The coil 31x generates an electromagnetic force in response to the lens drive current Mx input from the actuator driver 130, and moves the lens 2 in the X direction. The coil 31y generates an electromagnetic force in response to the lens drive current My input from the actuator driver 130, and moves the lens 2 in the Y direction.

Each of the position detection sensor 32x and the position detection sensor 32y is a magnetic sensor such as a Hall element utilizing a Hall effect. The position detection sensor 32x outputs a position detection signal Px, corresponding to the position of the lens 2 in the X direction moved by the driver 3, to the controller 110. The position detection sensor 32y outputs a position detection signal Py, corresponding to the position of the lens 2 in the Y direction moved by the driver 3, to the controller 110.

The controller 110 controls the operation of the light source driver 120 by outputting a light source control signal Is to the light source driver 120. Further, the controller 110 controls the operation of the driver 3 by outputting a lens control signal Nx and a lens control signal Ny to the actuator driver 130 based on the position detection signal Px and the position detection signal Py. The controller 110 includes a central processing unit (CPU) 111, a ROM 112, a RAM 113, and a connection interface (I/F) 114. These components are communicably connected to each other via a system bus B.

The CPU 111 executes control processing including various kinds of arithmetic processing. The ROM 112 stores programs used to drive the CPU 111, such as an initial program loader (IPL). The RAM 113 is used as a work area for the CPU 111. The connection I/F 114 is an interface for connecting the controller 110 to external devices. Examples of the external devices include the LiDAR device 400, the memory 500, the light source driver 120, the actuator driver 130, and the like.

### (Functional Configuration of Controller 110)

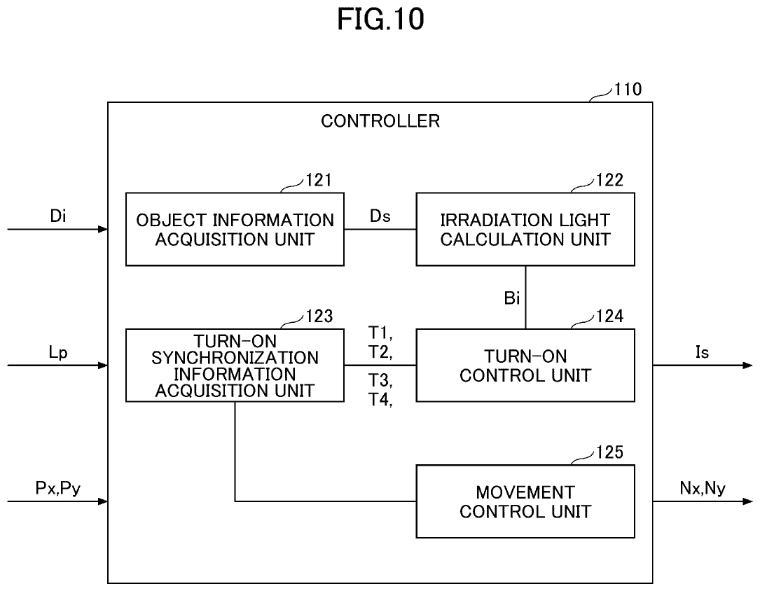

FIG. 10 is a block diagram illustrating a functional configuration of the controller 110. The controller 110 includes an object information acquisition unit 121, an irradiation light calculation unit 122, a turn-on synchronization information acquisition unit 123, a turn-on control unit 124, and a movement control unit 125. The controller 110 can implement the above-described functions by causing the CPU 111 to execute a program stored in the ROM 112. The controller 110 may include a functional configuration other than the above-described functional configuration. Further, the controller 110 may include an electric circuit such as an application specific integrated circuit (ASIC) or a field programmable gate array (FPGA), and the above-described functions can be implemented by the electric circuit. Further, the controller 110 can implement the above-described functions by distributed processing with other devices such as the smartphone 1000.

The controller 110 causes the irradiation light calculation unit 122 to calculate turn-on conditions of the light source 1 based on object information acquired by the object information acquisition unit 121, and controls turn-on of the light source 1 based on the turn-on conditions. For example, the controller 110 can perform control such that irradiation light becomes darker as an object is closer to the light-emitting module 100 according to distance information of the object acquired by the object information acquisition unit 121.

The object information acquisition unit 121 acquires, as an example of object information, distance information Ds of an object at each of a plurality of detection points on a second trajectory 210r, based on a distance image Di input from the LiDAR device 400. The object information acquisition unit 121 outputs the acquired results to the irradiation light calculation unit 122.

The object information refers to information on the object. The object information is not limited to the distance information Ds of the object, and may include at least one of distance information with respect to the object such as a subject, brightness information, or image information. The distance information means information on distances, the brightness information means information on brightness, and the image information means information on an image. The distance information Ds with respect to the object is not limited to information based on the distance image Di obtained by the LiDAR device 400, and may be information acquired by image processing or the like based on an image captured by the imaging device 300, for example. The brightness information is acquired based on, for example, an image captured by the imaging device 300. As the image information, an image captured by the imaging device 300 and the like can be used.

The object information may include information obtained by referring to the memory 500. If the memory 500 is referred to, the object information is acquired in advance and stored in the memory 500. The object information acquisition unit 121 can acquire the object information by referring to the memory 500. Alternatively, related information of the object information such as the distance image Di can be stored in the memory 500 in advance, and the object information acquisition unit 121 can acquire the object information based on the related information acquired by referring to the memory 500.

The irradiation light calculation unit 122 calculates turn-on conditions that are conditions for turning on the sixty-three light-emitting elements 12 included in the light source 1. For example, the irradiation light calculation unit 122 calculates turn-on conditions based on the distance information Ds from the object information acquisition unit 121. The turn-on conditions include brightness information of light from each of the light-emitting elements 12.

When one cycle T is defined as one round of a main light beam 2m of light transmitted through the lens 2 on a second trajectory 210r, the turn-on synchronization information acquisition unit 123 acquires information on a plurality of divided time periods obtained by dividing one cycle T. For example, in the present embodiment, the turn-on synchronization information acquisition unit 123 acquires information on a divided time period T1, a divided time period T2, a divided time period T3, and a divided time period T4 (hereinafter referred to as divided time periods T1 to T4) obtained by dividing the one cycle T into four. The information on the divided time periods T1 to T4 is information on the number of divisions P, which is the number of divisions of one cycle T, information on a light emission timing in each of the time periods, and the like. For example, the turn-on synchronization information acquisition unit 123 can acquire information on predetermined divided time periods T1 to T4 based on distances on the second trajectory 210r, the rotation speed of the lens 2, the number of divisions P, and the like, by referring to the ROM 112 and the like. The turn-on synchronization information acquisition unit 123 can output the information on the divided time periods T1 to T4 to the turn-on control unit 124.

The turn-on control unit 124 can change the brightness of the light from each of the light-emitting elements 12 in the divided time periods T1 to T4. For example, the turn-on control unit 124 changes the brightness of the light from each of the light-emitting elements 12 by using the light source control signal Is to control the light source driver 120 based on the turn-on conditions calculated by the irradiation light calculation unit 122. Further, the turn-on control unit 124 causes each of the light-emitting elements 12 to emit light at a timing based on the turn-on signal Lp input from the imaging module 200, the information on the divided time periods T1 to T4, the position detection signal Px, and the position detection signal Py. In accordance with the turn-on conditions calculated by the irradiation light calculation unit 122, the turn-on control unit 124 can cause each of the light-emitting elements 12 to emit individual light 210 in each of the divided time periods T1 to T4 in a state in which the lens 2 is rotated such that the optical axis 2a of the lens 2 moves on the first trajectory 2r.

The movement control unit 125 controls the movement of the lens 2 by the driver 3 by outputting the lens control signal Nx and the lens control signal Ny to the actuator driver 130. For example, the movement control unit 125 can control the start of the rotation of the lens 2, the stop of the rotation of the lens 2, the rotation speed and the rotation direction during the rotation of the lens 2, and the like. Further, the movement control unit 125 can perform feedback control of the movement of the lens 2 by the driver 3 based on the position detection signal Px and the position detection signal Py. The operation of the driver 3 is not necessarily controlled by the controller 110. For example, the driver 3 may make a relative rotation between the lens 2 and the light source 1 in response to a current applied from the actuator driver 130 at a predetermined timing.

### Example Operation of Light-Emitting Module 100

### (Movement Operation of Lens 2)

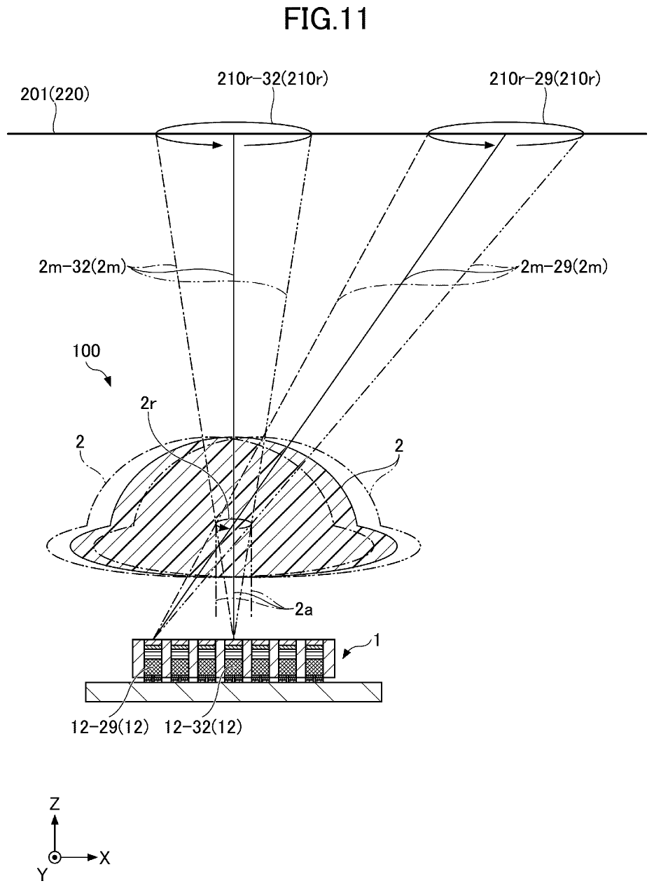

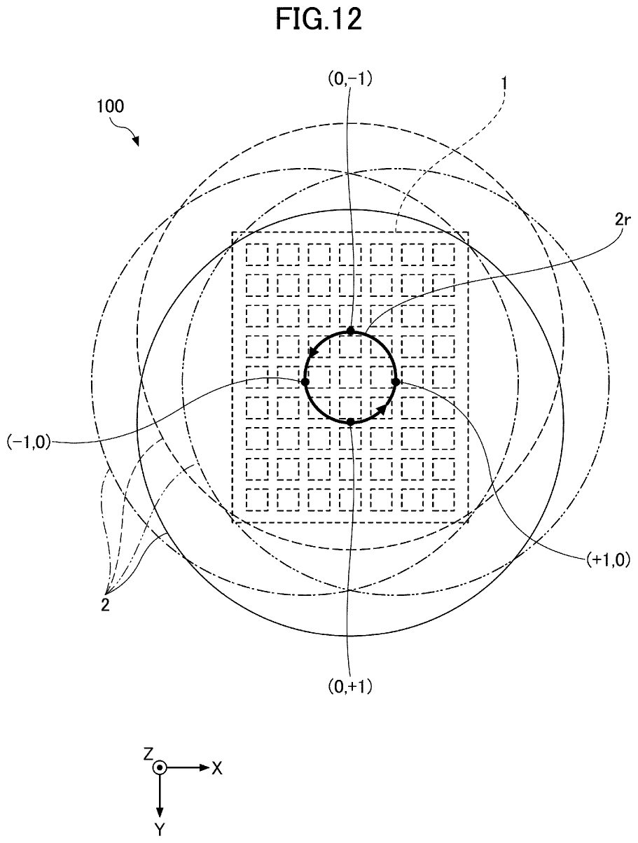

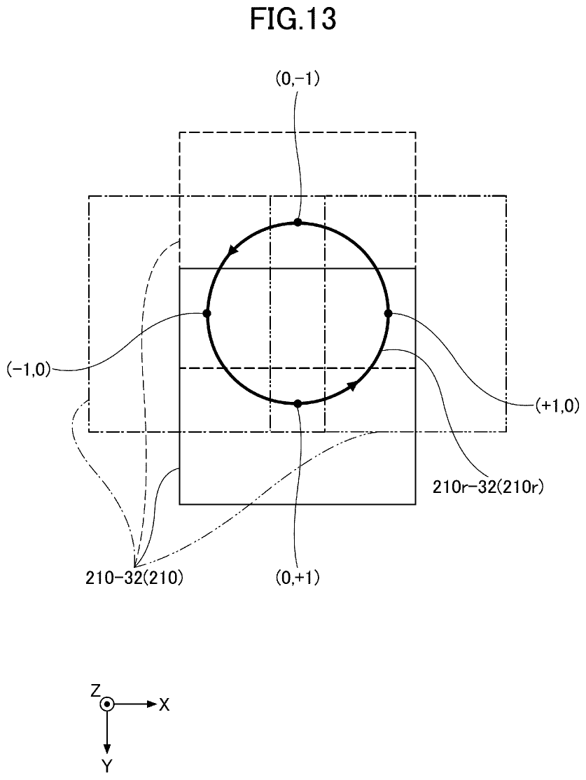

The movement of the lens 2 of the light-emitting module 100 will be described with reference to FIG. 11 to FIG. 13. FIG. 11 is a cross-sectional view illustrating the movement of the lens 2. FIG. 12 is a top view of the first trajectory 2r in FIG. 11. FIG. 13 is a top view of a second trajectory 210r in FIG. 11.

In FIG. 11, individual light 210 from the light-emitting element 12-32 after being transmitted through the lens 2 is emitted onto the irradiation region 220 as a portion of irradiation light 201. The main light beam 2m-32 of the individual light 210 from the light-emitting element 12-32 after being transmitted through the lens 2 is emitted so as to move on the second trajectory 210r-32, corresponding to the first trajectory 2r, according to the rotation of the lens 2. Further, individual light 210 from a light-emitting element 12-29 after being transmitted through the lens 2 is emitted onto the irradiation region 220 as a portion of the irradiation light 201. A main light beam 2m-29 of the individual light 210 from the light-emitting element 12-29 after being transmitted through the lens 2 is emitted so as to move on a second trajectory 210r-29, corresponding to the first trajectory 2r, according to the rotation of the lens 2.

In FIG. 12, a solid line, a dash-dot line, a dashed line, and a two-dot dash line indicate four states of the lens 2 during the rotation. The first trajectory 2r of the optical axis 2a accompanying the rotation of the lens 2 has a circular shape. The lens 2 moves such that the optical axis 2a rotates in a direction indicated by arrows on the first trajectory 2r, that is, in the counterclockwise direction. The two-dot dash line indicates a state in which the optical axis of the lens 2 is located at (+1, 0). The dashed line indicates a state in which the optical axis of the lens 2 is located at (0, −1). The dash-dot line indicates a state in which the optical axis of the lens 2 is located at (−1, 0). The solid line indicates a state in which the optical axis of the lens 2 is located at (0, +1). In the above description, for example, in (+1, 0), “+1” represents a normalized coordinate in the X direction, and “0” represents a normalized coordinate in the Y direction.

In FIG. 13, individual light 210-32 is individual light from the light-emitting element 12-32 among sixty-three individual lights 210. A solid line, a dash-dot line, a dashed line, and a two-dot dash line indicate four states of the individual light 210-32 during the rotation. The second trajectory 210r of the main light beam 2m-32 accompanying the rotation of the lens 2 has a circular shape. The main light beam 2m-32 moves so as to rotate in a direction indicated by arrows on the second trajectory 210r, that is, in the counterclockwise direction. The main light beam of the individual light 210-32 moves along the second trajectory 210r according to the rotation of the lens 2. In this example, the movement of the one individual light 210-32 of the sixty-three individual light beams 210 by the light-emitting module 100 is illustrated; however, individual lights other than the individual light 210-32 among the sixty-three individual lights 210 also move in the same or similar manner.

### (Method of Acquiring Distance Information Ds)

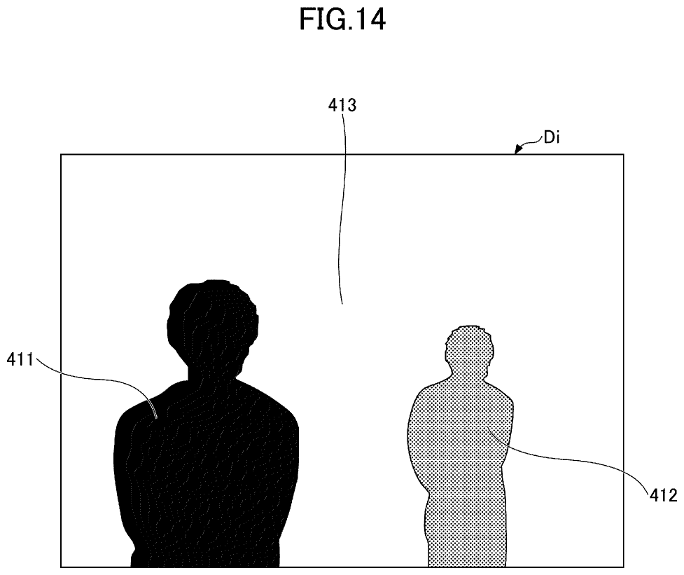

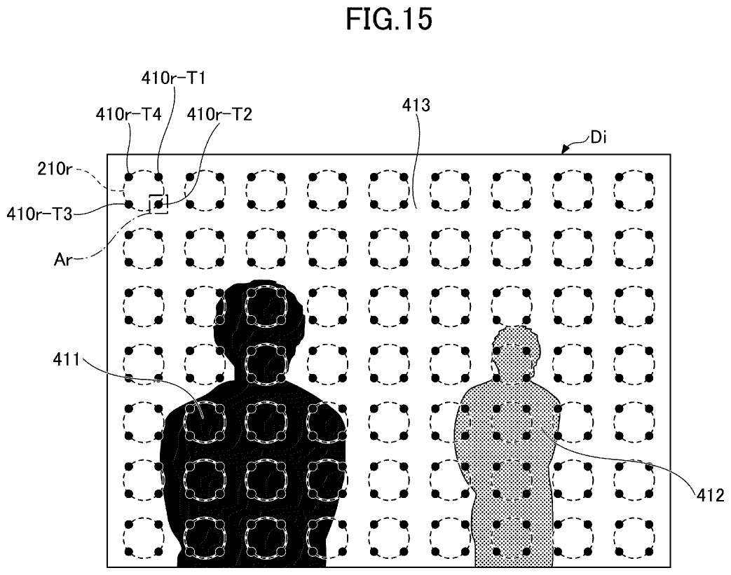

A method of acquiring distance information Ds by the object information acquisition unit 121 will be described with reference to FIG. 14 and FIG. 15. FIG. 14 is a diagram illustrating an example of a distance image Di output from the LiDAR device 400. FIG. 15 is a diagram illustrating a method of acquiring distance information Ds from the distance image Di of FIG. 14. In FIG. 15, for simplicity, it is assumed that the sizes of second trajectories 210r are the same although the sizes of the second trajectories 210r may vary according to the distances.

The distance image Di is an image having 256 pixels in the lateral direction and 192 pixels in the vertical direction, for example. The distance image Di includes distance information for each pixel. As illustrated in FIG. 14 and FIG. 15, the distance image Di includes a first object region 411, a second object region 412, and a background region 413. The distance image Di indicates that the darker the color of a region, the closer it is to the LiDAR device 400. In FIG. 14 and FIG. 15, the first object region 411 indicated by black is located closest to the LiDAR device 400, the second object region 412 indicated by dot hatching is located farther from the LiDAR device 400 than the first object region 411 is, and the background region 413 indicated by white is located farther from the LiDAR device 400 than the second object region 412 is.

The main light beams of the sixty-three individual lights 210 rotate along the respective second trajectories 210r by the rotation of the lens 2. The distance image Di includes regions corresponding to regions where the main light beams of the sixty-three individual lights 210 rotate along the respective second trajectories 210r.

FIG. 15 illustrates the second trajectories 210r of the sixty-three individual lights 210 in the distance image Di. The second trajectories 210r are trajectories of the sixty-three individual lights 210.

The light-emitting module 100 can cause the turn-on control unit 124 to change the brightness of each of the individual lights 210 of the light-emitting elements 12 in the divided time periods T1 to T4. For this purpose, the light-emitting module 100 acquires distance information Ds by causing the object information acquisition unit 121 to extract distance information Ds at a detection point 410r-T1, a detection point 410r-T2, a detection point 410r-T3, and a detection point 410r-T4 on a second trajectory 210r from the distance image Di.

The detection point 410r-T1 corresponds to one point on the second trajectory 210r through which a main light beam 2m passes during the divided time period T1. The detection point 410r-T2 corresponds to one point on the second trajectory 210r through which the main light beam 2m passes during the divided time period T2. The detection point 410r-T3 corresponds to one point on the second trajectory 210r through which the main light beam 2m passes during the divided time period T3. The detection point 410r-T4 corresponds to one point on the second trajectory 210r through which the main light beam 2m passes during the divided time period T4. One cycle T is divided into a plurality of time periods during each of which the main light beam 2m of individual light 210 passes through a corresponding one of the detection point 410r-T1, the detection point 410r-T2, the detection point 410r-T3, and the detection point 410r-T4. The number of detection points can be appropriately changed according to the number of divisions of one cycle T.

For each of the sixty-three individual lights 210, the object information acquisition unit 121 acquires distance information Ds at a detection point 410r-T1, a detection point 410r-T2, a detection point 410r-T3, and a detection point 410r-T4. In the present embodiment, the object information acquisition unit 121 can acquire 63×4=252 pieces of distance information Ds in one cycle T.

Object information at each detection point may be calculated based on an object information group in a detection region including the detection point. In FIG. 15, a detection region Ar is a predetermined region including the detection point 410r-T2. In the present embodiment, the object information acquisition unit 121 can acquire, as distance information Ds of the detection point 410r-T2, the minimum value of distance information Ds of all pixels included in the detection region Ar. If object information is acquired from the detection region Ar, distance information Ds is calculated based on an object information group of pixels included in the detection region Ar. The size and the shape of the detection region Ar can be appropriately changed. Further, the distance information Ds of the detection point 410r-T2 is not limited to the minimum value of the distance information Ds of all the pixels included in the detection region Ar, and may be the maximum value, the mean value, or the median of the distance information Ds of all the pixels included in the detection region Ar.

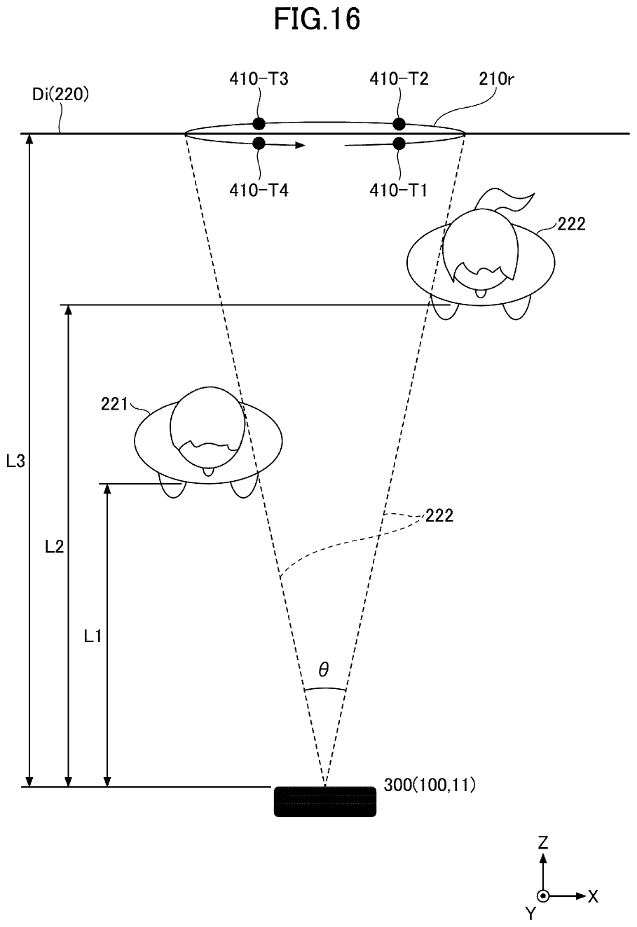

FIG. 16 is a diagram illustrating an example of the relationship between a distance image Di and a second trajectory 210r. The first object 221 is located at a position away from the imaging device 300 including the light-emitting module 100 by an object distance L1, the second object 222 is located at a position away from the imaging device 300 including the light-emitting module 100 by an object distance L2, and the irradiation region 220 is located at a position away from the imaging device 300 including the light-emitting module 100 by an object distance L3. The irradiation region 220 corresponds to the background. For example, the object distance L1 is 1 m, the object distance L2 is 2 m, and the object distance L3 is 3 m. An angle θ is the apex of a cone including a light emitting point on a light-emitting surface 11 and the second trajectory 210r.

The second trajectory 210r indicates a shape corresponding to the first trajectory 2r. In the cone including the light emitting point on the light-emitting surface 11 and the second trajectory 210r in the irradiation region and having the apex of the angle θ, the second trajectory 210r is a cross section parallel to the bottom surface of the cone. The size of the second trajectory 210r varies according to the distance between the light-emitting surface 11 and an object. The light-emitting module 100 and the light-emitting surface 11 are included in the imaging device 300, and thus the reference numerals of the light-emitting module 100 and the light-emitting surface 11 are indicated in parentheses together with the reference numeral of the imaging device 300 in FIG. 16.

### (Method of Calculating Turn-on Conditions)

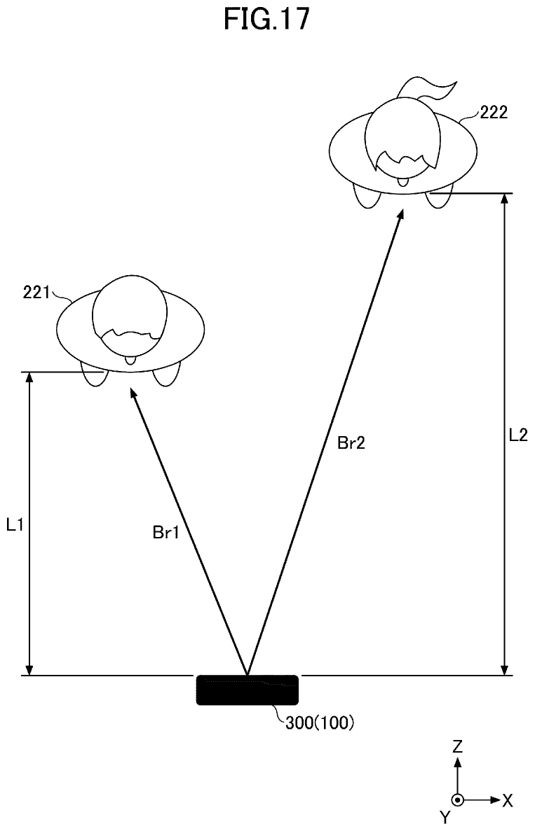

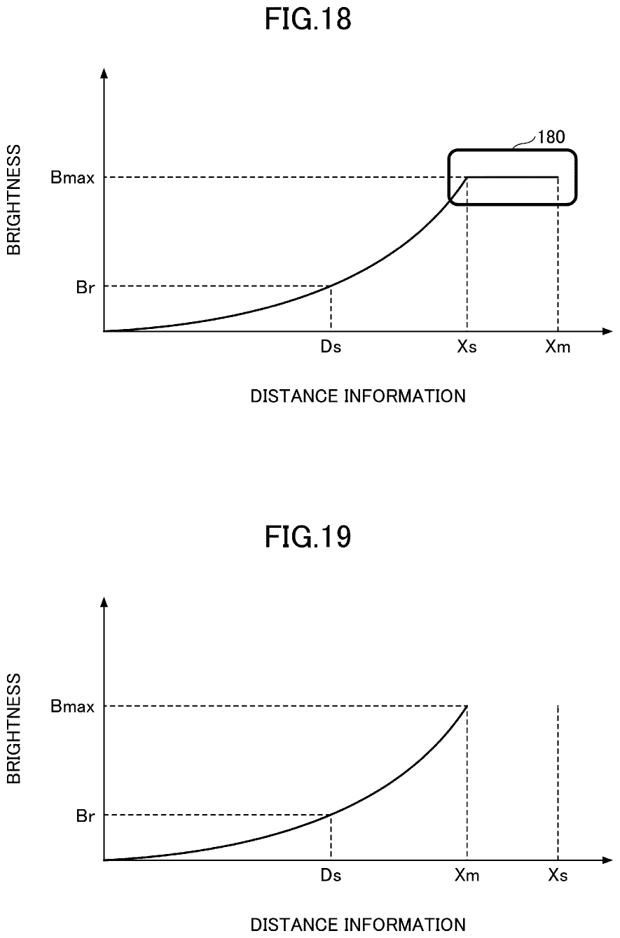

A method of calculating turn-on conditions by the irradiation light calculation unit 122 will be described with reference to FIG. 17 to FIG. 19. In the following, a method of calculating brightness, which is an example of turn-on conditions, will be described. FIG. 17 is a diagram illustrating an example of the relationship between an object distance and the brightness of irradiation light 201 to an object. FIG. 18 is a diagram illustrating a first example of a change in the brightness of the irradiation light 201 according to the object distance. FIG. 19 is a diagram illustrating a second example of a change in the brightness of the irradiation light 201 according to the object distance.

As illustrated in FIG. 17, the first object 221 is located at a position away from the imaging device 300 including the light-emitting module 100 by the object distance L1, and the second object 222 is located at a position away from the imaging device 300 including the light-emitting module 100 by the object distance L2. The irradiation light calculation unit 122 illustrated in FIG. 10 calculates brightness Br of individual light 210 of each of the light-emitting elements 12 at each of a detection point 410r-T1, a detection point 410r-T2, a detection point 410r-T3, and a detection point 410r-T4 by referring to the maximum distance Xm of pieces of distance information Ds or a set reference distance Xs, the maximum brightness Bₘₐₓ of the individual light 210, and distance information Ds acquired by the object information acquisition unit 121. Based on calculation results by the irradiation light calculation unit 122, the light-emitting module 100 can irradiate the first object 221 with irradiation light 201 having brightness Br1 corresponding to the object distance L1 and irradiate the second object 222 with irradiation light 201 having brightness Br2 corresponding to the object distance L2.

FIG. 18 illustrates a case in which the maximum distance Xm of the pieces of distance information Ds acquired by the object information acquisition unit 121, is greater than the reference distance Xs. In this case, the brightness Br of the individual light 210 of each of the light-emitting elements 12 at each of the detection point 410r-T1, the detection point 410r-T2, the detection point 410r-T3, and the detection point 410r-T4 is defined by Formula (1) below, where Bₘₐₓ denotes the maximum brightness of the individual light 210.

Br=Bₘₐₓ×Ds²/Xs² (1)

The irradiation light calculation unit 122 can calculate the brightness Br by using the above Formula. In a region 180 surrounded by a rectangle in FIG. 18, the brightness Bₘₐₓ with respect to the distance greater than or equal to the reference distance Xs is constant. Alternatively, the brightness Bₘₐₓ with respect to the distance greater than or equal to the reference distance Xs may be set to 0.

Conversely, FIG. 19 illustrates a case in which the maximum distance Xm of the pieces of distance information Ds acquired by the object information acquisition unit 121, is less than the reference distance Xs. In this case, the brightness Br of the individual light 210 of each of the light-emitting elements 12 at each of the detection point 410r-T1, the detection point 410r-T2, the detection point 410r-T3, and the detection point 410r-T4 is defined by Formula (2) below, where Bₘₐₓ denotes the maximum brightness of the individual light 210.

Br=Bₘₐₓ×Ds²/Xm² (2)

The irradiation light calculation unit 122 can calculate the brightness Br by using the above Formula.

### (Irradiation Operation by Light-Emitting Module 100)

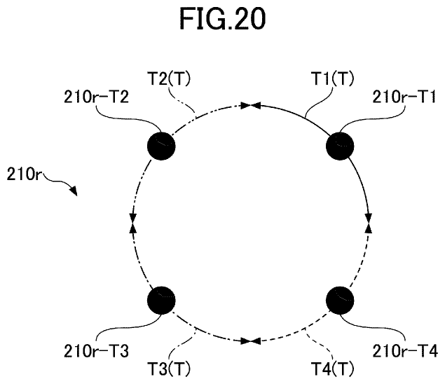

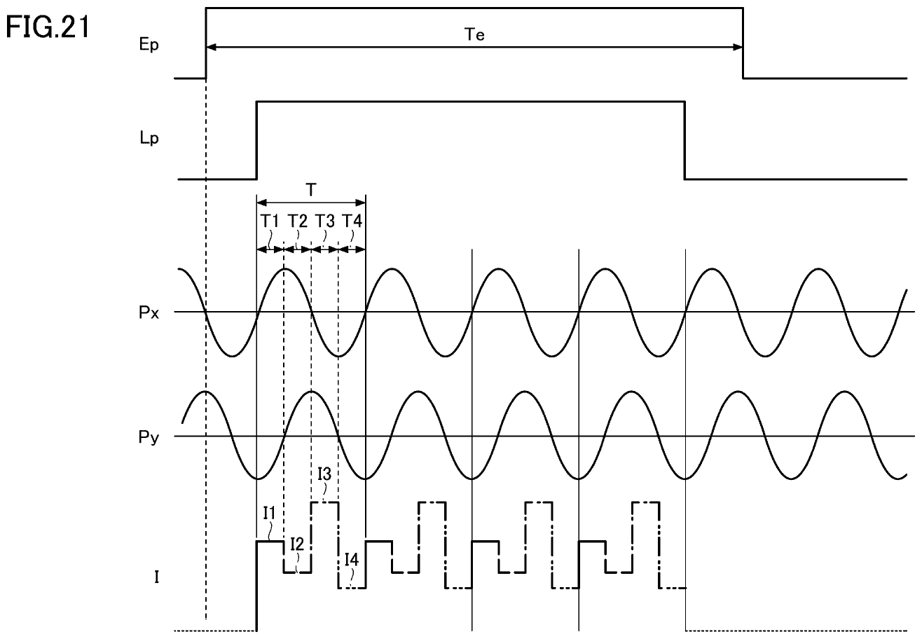

An irradiation operation by the light-emitting module 100 will be described with reference to FIG. 20 and FIG. 21. FIG. 20 is a diagram illustrating an example of divided time periods. FIG. 21 is a timing chart illustrating an irradiation operation by the light-emitting module 100. In FIG. 20 and FIG. 21, an irradiation operation of one individual light 210 by the light-emitting module 100 will be described. The light-emitting module 100 can perform the same irradiation operation for each of the sixty-three individual lights 210.

FIG. 20 illustrates a second trajectory 210r. The rotation time in which a main light beam 2m makes one round on the second trajectory 210r according to the rotation of the lens 2 corresponds to one cycle T. The rotation frequency of the lens 2 is 120 Hz as an example, and in this case, one cycle T is 8.3 ms.

A divided time period T1 indicated by a solid line, a divided time period T2 indicated by a two-dot dash line, a divided time period T3 indicated by a dash-dot line, and a divided time period T4 indicated by a dashed line are divided time periods obtained by dividing one cycle T into four. A range from a start point to an end point indicated by arrows represents the length of each of the divided time periods. The number of divisions P is not limited to four, and can be appropriately changed according to the spatial resolution required for irradiation light 201, and the like.

Each of a second trajectory irradiation point 210r-T1, a second trajectory irradiation point 210r-T2, a second trajectory irradiation point 210r-T3, and a second trajectory irradiation point 210r-T4 on the second trajectory 210r represents one timing in a corresponding divided time period among the divided time periods T1 to T4. The second trajectory irradiation point 210r-T1, the second trajectory irradiation point 210r-T2, the second trajectory irradiation point 210r-T3, and the second trajectory irradiation point 210r-T4 are points respectively corresponding to a detection point 410r-T1, a detection point 410r-T2, a detection point 410r-T3, and a detection point 410r-T4 at each of which distance information Ds is acquired. The second trajectory irradiation point 210r-T1 is one timing in the divided time period T1, the second trajectory irradiation point 210r-T2 is one timing in the divided time period T2, the second trajectory irradiation point 210r-T3 is one timing in the divided time period T3, and the second trajectory irradiation point 210r-T4 is one timing in the divided time period T4. A detection point may be a start point or an end point of a divided time period. A detection point may be a point between a start point or an end point of each of the divided time periods T1 to T4 illustrated in FIG. 20.

In the light-emitting module 100, the brightness Br of individual light 210 in each of the divided time periods T1 to T4. The brightness of the individual light 210 is the same within one divided time period. For example, when one divided time period transitions to another divided time period, for example, when the divided time period T1 transitions to the divided time period T2, the brightness of the individual light 210 is changed. However, the brightness of the individual light 210 does not have to be changed before and after the transition between the divided time periods.

FIG. 21 illustrates, from the upper side to the lower side, an exposure signal Ep, a turn-on signal Lp, a position detection signal Px, a position detection signal Py, and a light source drive current I. An exposure time Te is an exposure time in the imaging module 200. The turn-on signal Lp indicates a timing at which a light-emitting element 12 is turned on. A time period in which the light-emitting element 12 is turned on in response to the turn-on signal Lp is shorter than an exposure time period. The lens 2 rotates such that the first trajectory 2r is circular, and thus the position detection signal Px and the position detection signal Py are sine wave signals whose phases are shifted from each other by 90 degrees.

The turn-on control unit 124 determines an irradiation timing for each divided time period based on the position detection signal Px and the position detection signal Py. The light source driver 120 can apply a light source drive current I to the light-emitting element 12 in response to a light source control signal Is from the turn-on control unit 124. The light-source driver 120 applies, to the light-emitting element 12, a light source drive current I1 in the divided time period T1, a light source drive current 12 in the divided time period T2, a light source drive current 13 in the divided time period T3, and a light source drive current 14 in the divided time period T4 according to timings determined by the turn-on control unit 124. The brightness of light from the light-emitting element 12 changes according to the light source drive current I1, the light source drive current 12, the light source drive current 13, and the light source drive current 14.

As described above, the light-emitting module 100 can emit individual light 210 having different brightness in each of the divided time periods T1 to T4, as four individual lights 210. The individual lights 210 move on the second trajectory 210r within one cycle T. Thus, the four individual lights 210 having different brightness are emitted to different positions along the second trajectory 210r such that the individual lights 210 partially overlap each other. By causing the individual lights 210 having different brightness to partially overlap each other, the spatial resolution of irradiation light 201 is increased as compared to a case in which the individual lights 210 do not overlap.

Further, in the present embodiment, the rotation frequency of the lens 2 is high as compared to the exposure time period of the imaging device 300. One cycle T in which the optical axis 2a of the lens 2 makes one round on the first trajectory 2r is, for example, 8.3 ms. For example, when a photographer using the smartphone 1000 captures a moving image, the photographer cannot visually perceive the movement of individual light 210 along a second trajectory 210r with the naked eyes. Thus, flickering of the individual light 210 accompanying the rotation of the lens 2 can be suppressed by an afterimage effect of human eyes. As a result, the influence on the photographer's eyes can be suppressed. One cycle T is not limited to 8.3 ms, and the effect of flickering suppression of the individual light 210 can be suppressed as long as one cycle T is 30 ms or less. Further, the optical axis 2a of the lens 2 preferably makes three or more rounds on the first trajectory 2r during the exposure time Te. From another point of view, one cycle T is preferably less than Te/3. Accordingly, spots on a captured image can be reduced. The term “spot” refers to a phenomenon in which the brightness of irradiation light becomes spotted.

In the example of FIG. 21, four sets of the divided time periods T1 to T4 are included in the exposing time Te, and thus the four individual lights 210 overlapping each other are emitted four times. The imaging device 300 can obtain brightness obtained by integrating at least four irradiation lights emitted four times in one image capturing, and thus can suitably secure brightness. From the viewpoint of suppressing spots, the exposure time Te is preferably a natural number multiple of one cycle T. This is because if the exposure time Te is a natural number multiple of one cycle T, the brightness of irradiation light for each exposure time Te tends to be constant.

### (Irradiation Process by Controller 110)

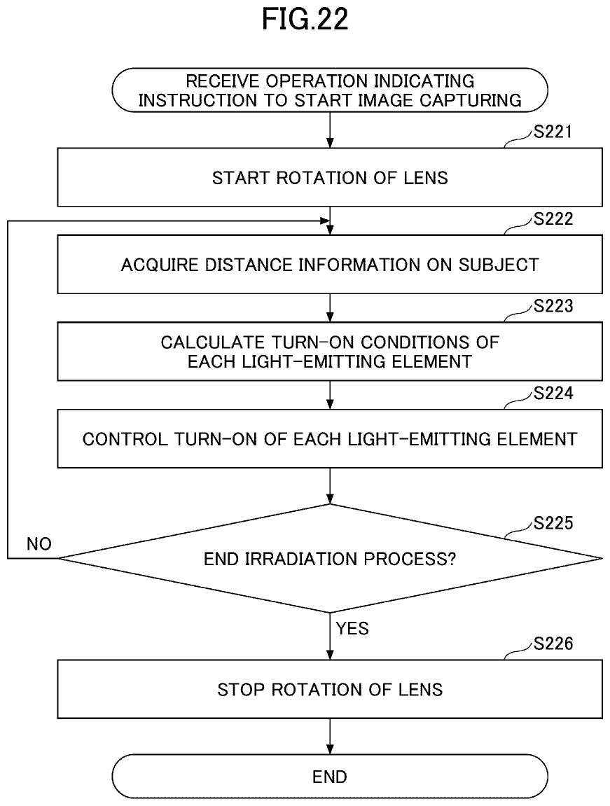

FIG. 22 is a flowchart illustrating an irradiation process performed by the controller 110. It is assumed that the smartphone 1000 in which the imaging device 300 is installed is activated.

For example, the controller 110 starts the process of FIG. 22 in response to receiving an operation input indicating an instruction to start image capturing via an operation unit of the smartphone 1000. However, the start timing of the process of FIG. 22 by the controller 110 is not limited to the above, and the controller 110 may start the process of FIG. 22 in response to receiving an operation input indicating an instruction to start light emission via the operation unit. At a time when the process is started, the measurement of distances is already completed by the LiDAR device 400, and an distance image Di can be input from the LiDAR device 400.

First, in step S221, the controller 110 allows the movement control unit 125 to start rotation of the lens 2 by the driver 3. Thereafter, the lens 2 continues to rotate until the controller 110 allows the movement control unit 125 to stop the rotation of the lens 2. Starting rotation of the lens 2 may be performed in any step before step S224 in which the controller 110 controls turn-on of each of light-emitting elements 12.

Subsequently, in step S222, the controller 110 causes the object information acquisition unit 121 to acquire distance information Ds at a detection point 410r-T1, a detection point 410r-T2, a detection point 410r-T3, and a detection point 410r-T4 on a second trajectory 210r. Step S222 corresponds to an object information acquisition step.

Subsequently, in step S223, the controller 110 causes the irradiation light calculation unit 122 to calculate turn-on conditions of individual light 210 of each of the light-emitting elements 12 at the detection point 410r-T1, the detection point 410r-T2, the detection point 410r-T3, and the detection point 410r-T4, based on the distance information Ds at the detection point 410r-T1, the detection point 410r-T2, the detection point 410r-T3, and the detection point 410r-T4. The turn-on conditions include the brightness of the individual light 210. Step S223 corresponds to a irradiation light calculation step. The irradiation light calculation unit 122 outputs the calculated results to the turn-on control unit 124.

Subsequently, in step S224, the controller 110 causes the turn-on control unit 124 to change the brightness of the light of each of the light-emitting elements 12 by using a light source control signal Is to control the light source driver 120 based on the turn-on conditions. For example, the controller 110 causes the turn-on control unit 124 to cause each of the light-emitting elements 12 to emit the individual light 210, which corresponds to the turn-on conditions calculated in step S223, in the divided time periods T1 to T4 in a state in which the lens 2 is rotated such that the optical axis 2a of the lens 2 moves on the first trajectory 2r. Step S224 corresponds to an irradiation step. Each of the light-emitting elements 12 is turned off within the exposure time Te. By performing step S224, individual lights 210 having different brightness in each of the divided time periods T1 to T4 are emitted to different positions along the second trajectory 210r such that the individual lights 210 partially overlap each other. The imaging device 300 can capture an image of an object by emitting irradiation light 201 having irradiation light patterns with increased spatial resolution and along the contours of the objects.

Subsequently, in step S225, the controller 110 determines whether to end the irradiation process. For example, the controller 110 determines to end the irradiation process if an operation input indicating an instruction to end image capturing by the imaging device 300 is performed by the photographer using the operation unit of the smartphone 1000. The controller 110 determines not to end the irradiation process in other cases.

If the controller 110 determines not to end the irradiation process in step S225 (NO in step S225), the controller 110 performs step S222 and the subsequent steps again. Conversely, if the controller 110 determines to end the irradiation process in step S225 (YES in step S225), the controller 110 causes the movement control unit 125 to stop the rotation of the lens 2 by the driver 3 in step S226. Thereafter, the controller 110 ends the irradiation process.

In this manner, the irradiation process can be performed by the controller 110 included in the light-emitting module 100.

### Example of Irradiation Light 201

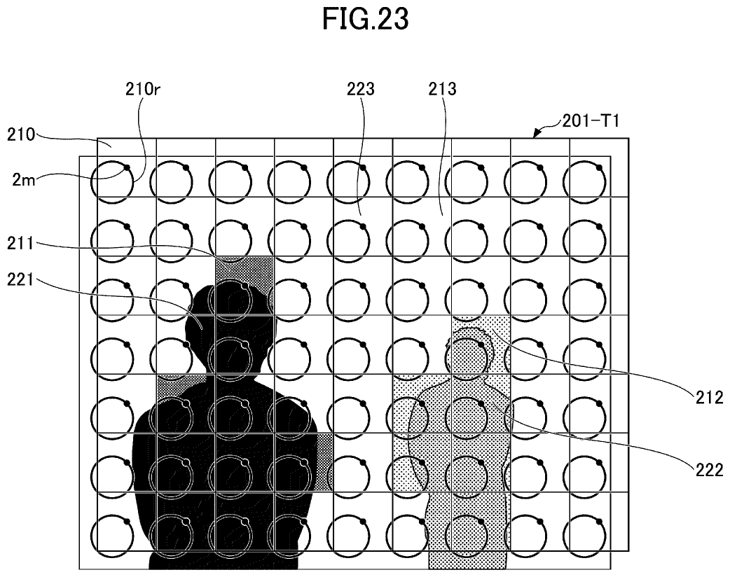

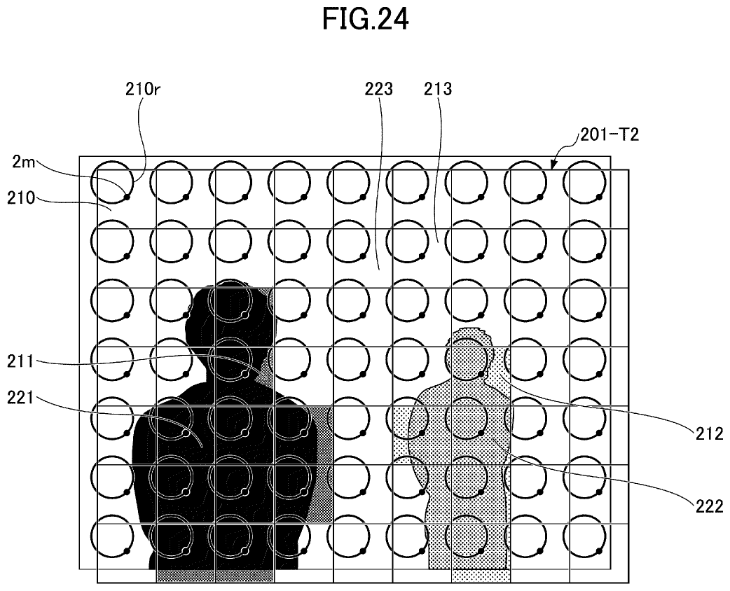

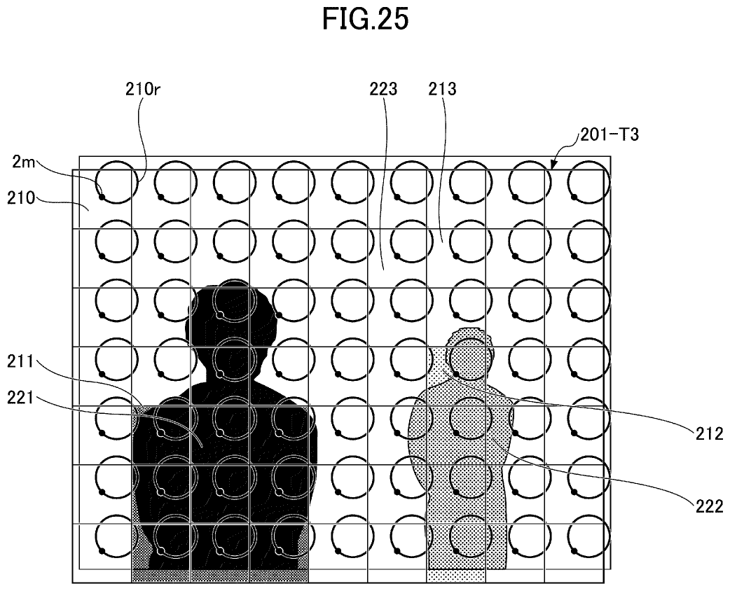

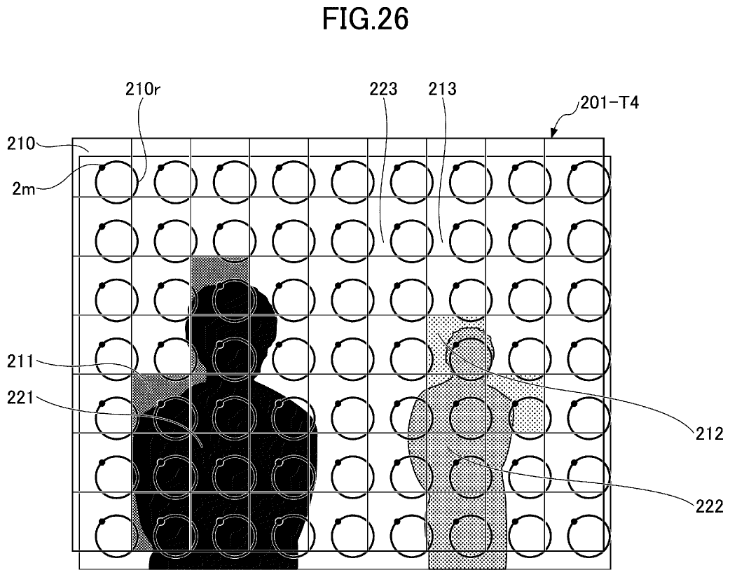

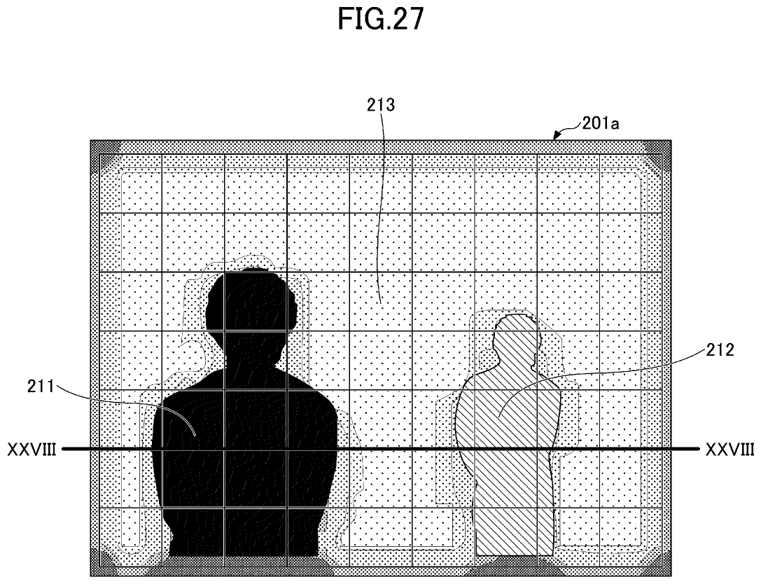

Irradiation light 201 obtained by the light-emitting module 100 will be described with reference to FIG. 23 to FIG. 27. Each of FIG. 23 to FIG. 26 is a diagram illustrating irradiation light 201 obtained by the light-emitting module at one timing in a divided time period. FIG. 23 illustrates irradiation light 201 at one timing in the divided time period T1. FIG. 24 illustrates irradiation light 201 at one timing in the divided time period T2. FIG. 25 illustrates irradiation light 201 at one timing in the divided time period T3. FIG. 26 illustrates irradiation light 201 at one timing in the divided time period T4. FIG. 27 is a diagram illustrating a result of overlapping the irradiation lights 201. In each of FIG. 23 to FIG. 27, dot hatching represents the brightness of individual light 210 included in irradiation light 201. Dot hatching with a narrower interval between dots means that individual light 210 is darker. Dot hatching with a wider interval between dots means that individual light 210 is brighter.

In the divided time period T1, irradiation light 201-T1 including sixty-three individual lights 210 is emitted such that the main light beam 2m of each of the sixty-three individual lights 210 passes through a region corresponding to the divided time period T1 on a second trajectory 210r. The irradiation light 201-T1 in FIG. 23 is irradiation light at one timing in the divided time period T1.

In the divided time period T2, irradiation light 201-T2 including the sixty-three individual lights 210 is emitted such that the main light beam 2m of each of the sixty-three individual lights 210 passes through a region corresponding to the divided time period T2 on the second trajectory 210r. The irradiation light 201-T2 in FIG. 24 is irradiation light at one timing in the divided time period T2.

In the divided time period T3, irradiation light 201-T3 including the sixty-three individual lights 210 is emitted such that the main light beam 2m of each of the sixty-three individual lights 210 passes through a region corresponding to the divided time period T3 on the second trajectory 210r. The irradiation light 201-T3 in FIG. 25 is irradiation light at one timing in the divided time period T3.

In the divided time period T4, irradiation light 201-T4 including the sixty-three individual lights 210 is emitted such that the main light beam 2m of each of the sixty-three individual lights 210 passes through a region corresponding to the divided time period T4 on the second trajectory 210r. The irradiation light 201-T4 in FIG. 26 is irradiation light at one timing in the divided time period T4.

Regions corresponding to the background 223 are irradiated with background irradiation light 213 included in each of the irradiation light 201-T1, the irradiation light 201-T2, the irradiation light 201-T3, and the irradiation light 201-T4. Regions corresponding to the second object 222 are irradiated with second object irradiation light 212 that is darker than the background irradiation light 213. Regions corresponding to the first object 221 are irradiated with first object irradiation light 211 that is darker than the second object irradiation light 212.

The relative positions of the sixty-three individual lights 210 with respect to the first object 221 and the second object 222 differ in each of the divided time periods T1 to T4. Therefore, the irradiation light patterns in each of the divided time periods T1 to T4 are slightly different from each other for the first object irradiation light 211 and the second object irradiation light 212.

Assuming the object distances are substantially the same in the regions corresponding to the first object 221, a plurality of individual lights 210 constituting the first object irradiation light 211 have the same brightness. Similarly, assuming the object distances are substantially the same in the regions corresponding to the second object 222, a plurality of individual lights 210 constituting the second object irradiation light 212 have the same brightness.

The spatial resolution of each of the irradiation light 201-T1, the irradiation light 201-T2, the irradiation light 201-T3, and the irradiation light 201-T4 is determined by the size of individual light 210. Thus, the spatial resolution of each irradiation light pattern is low. That is, the first object irradiation light 211 is emitted to a portion other than the first object 221, or a portion of the first object 221 is not irradiated with the first object irradiation light 211. Similarly, the second object irradiation light 212 is emitted to a portion other than the second object 222, or a portion of the second object 222 is not irradiated with the second object irradiation light 212.

As illustrated in FIG. 27, by overlapping the irradiation lights in the divided time periods T1 to T4, brightness other than the brightness of the first object irradiation light 211, the brightness of the second object irradiation light 212, and the brightness of the background irradiation light 213 is produced. The produced brightness allows each of regions irradiated with individual lights 210 to be further divided, and the spatial resolution of irradiation light 201 can be increased as compared to when individual lights 210 do not overlap. In the present embodiment, a region irradiated with individual light 210 can be divided into four. By increasing the spatial resolution of the irradiation light 201, the light-emitting module 100 can increase the resolution of patterns of the irradiation light 201, and can emit the irradiation light 201 having irradiation light patterns along the contours of the first object 221 and the second object 222.

FIG. 27 is a contour diagram illustrating an illuminance distribution 201a of the irradiation light 201 by the light-emitting module 100. FIG. 28 is a diagram illustrating a cross-sectional illuminance distribution taken through the line XXVIII-XXVIII of FIG. 27. FIG. 27 and FIG. 28 illustrate simulation results obtained by using an illumination analysis software.

In the illuminance distribution 201a illustrated in FIG. 27, the display color becomes closer to white as the illuminance increases. The illuminance of the second object irradiation light 212 is lower than the illuminance of the background irradiation light 213, and the illuminance of the first object irradiation light 211 is lower than the illuminance of the second object irradiation light 212.

In FIG. 28, a graph curve 301 indicates the contours of the first object 221 and the second object 222. A graph curve 302 indicates the illuminance distribution. As illustrated in FIG. 28, it can be seen that the illuminance distribution along the contours of the first object 221 and the second object 222 is obtained. Further, it can be seen that the illuminance distribution changes in the vicinities of the objects so as to intersect the contours of the objects. Therefore, irradiation of light gradually changes at the contours of the objects in an actual captured image, and thus the image with less conspicuous spots can be obtained.

### Example of Evaluation Results of Amounts of Deviation of Irradiation Light Patterns from Contours of Objects

Evaluation results of the amounts of deviation of irradiation light patterns from the contours of objects will be described.

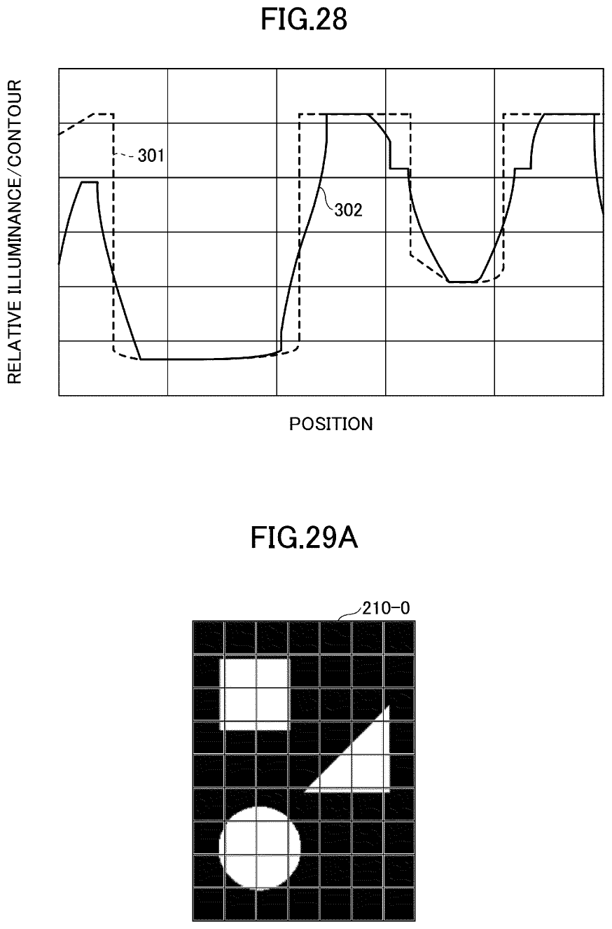

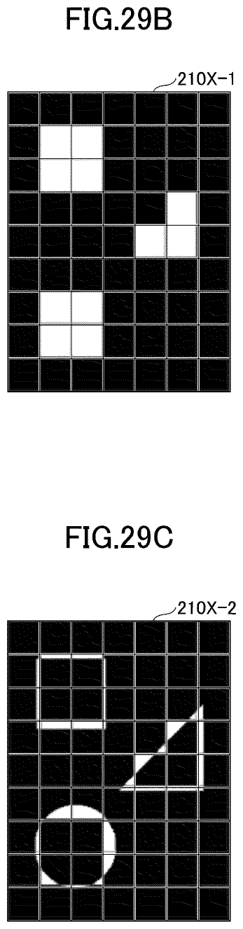

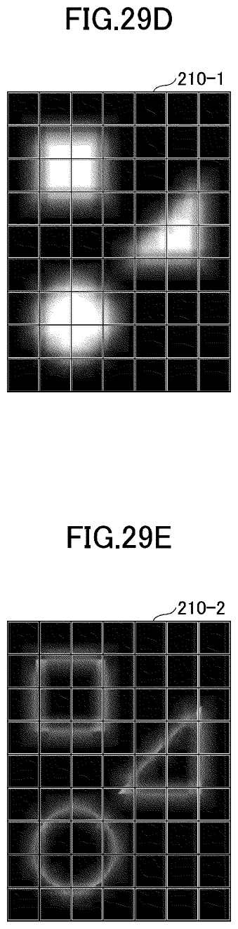

FIG. 29A to FIG. 29E are diagrams illustrating results of quantitative evaluation of the amounts of deviation of irradiation light patterns from the contours of objects. The results are obtained by simulations of the irradiation light patterns by using a computer. FIG. 29A is a diagram illustrating an evaluation chart 210-0. FIG. 29B is a diagram illustrating a conventional irradiation light image 210X-1. FIG. 29C is a diagram illustrating a difference image 210X-2 between the images of FIG. 29A and FIG. 29B. FIG. 29D is a diagram illustrating an irradiation light image 210-1 according to the embodiment. FIG. 29E is a diagram illustrating a difference image 210-2 between the images of FIG. 29A and FIG. 29D.

In FIG. 29A to FIG. 29E, as an image region is brighter, irradiation light is brighter. The irradiation light image 210X-1 in FIG. 29B indicates irradiation patterns obtained by a conventional light-emitting module based on the evaluation chart 210-0. The difference image 210X-2 in FIG. 29C indicates results obtained by difference processing between the evaluation chart 210-0 and the irradiation light image 210X-1. The sum of pixel brightness of the difference image 210X-2 is denoted as St.

The irradiation light image 210-1 in FIG. 29D indicates irradiation patterns obtained by the light-emitting module 100 according to the embodiment based on the evaluation chart 210-0. FIG. 29E indicates results obtained by difference processing between the evaluation chart 210-0 and the irradiation light image 210-1. The sum of pixel brightness of the difference image 210-2 is denoted as Sh.

The irradiation light image 210-1 is obtained as an image in which the irradiation patterns are along the contours of the evaluation chart 210-0, as compared to the irradiation light image 210X-1. The difference image 210-2 is darker than the difference image 210X-2. From this, it can be seen that the amount of deviation between the contour of the irradiation light image 210-1 and the contour of the evaluation chart 210-0 is smaller than the amount of deviation between the contour of the irradiation light image 210X-1 and the contour of the evaluation chart 210-0.

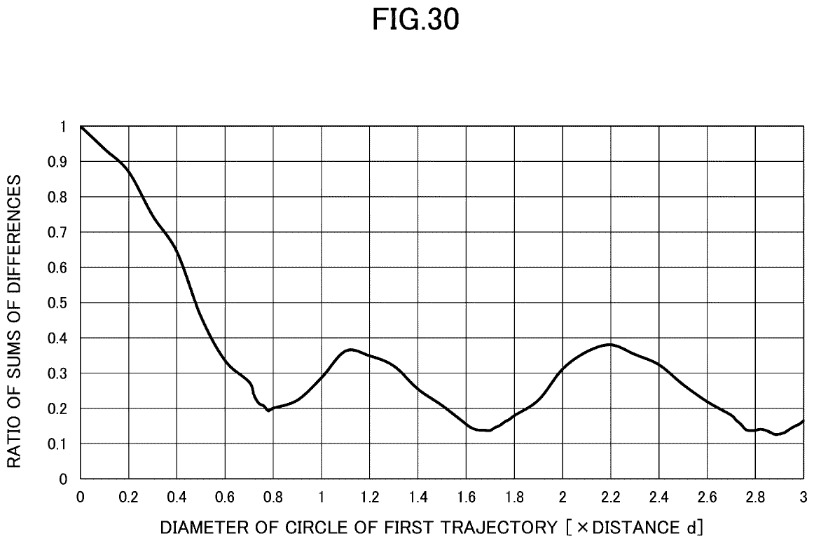

FIG. 30 is a diagram illustrating an example of quantitative evaluation results of the amounts of deviation of the irradiation light patterns from the contours of the objects. The horizontal axis of FIG. 30 represents the diameter of a circle of the first trajectory 2r. The diameter of the circle is represented by a multiple of the distance d between the centers of adjacent light-emitting elements 12. The vertical axis of FIG. 30 represents the ratio of the sums of differences. The ratio of the sums of differences is a value obtained by dividing the total pixel brightness Sh in the light-emitting module 100 by the total pixel brightness St in the conventional light-emitting module.

As illustrated in FIG. 30, values of the ratio Sh/St of the sums of differences are the minimum values when the diameter of the circle of the first trajectory 2r is in the range of 0.7 times to 0.9 times, 1.6 times to 1.8 times, and 2.75 times to 2.95 times the distance d. From the above, it can be seen that, in order to reduce the amount of deviation between the irradiation light patterns and the contours of the objects, the diameter of the circle of the first trajectory 2r is preferably greater than 0 times and 3 times or less the distance d. Further, the diameter of the circle of the first trajectory 2r is particularly preferably in the range of 0.7 times to 0.9 times, 1.6 times to 1.8 times, and 2.75 times to 2.95 times the distance d.

### Another Example Configuration of Light Source 1

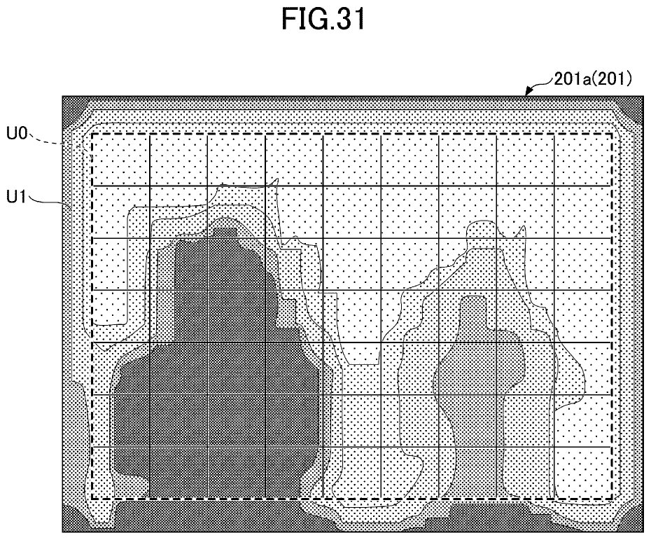

The light-emitting module 100 emits a plurality of irradiation lights 201 in an overlapping manner while rotating the lens 2, and thus the illuminance at the outer edges of the irradiation lights 201 may be reduced. FIG. 31 is a contour diagram illustrating a reduction in illuminance at the outer edge of irradiation light 201. FIG. 31 illustrates an illuminance distribution 201a of the irradiation light 201.

An outer edge U1 is a rectangular frame-shaped region that is the outer edge of the irradiation light 201. The number of overlapping individual lights 210 at the outer edge U1 is smaller than that in an effective region U0 because there are no individual lights 210 outside the outer edge U1. Thus, the illuminance at the outer edge U1 is lower than the illuminance in the effective region U0. The effective region U0 is a region where desired illuminance can be obtained by the irradiation light 201. The light-emitting module 100 has the outer edge U0 at which illuminance is low, and thus the effective region U1 of the irradiation light 201 may be narrowed. Therefore, in the present embodiment, the light source 1 may have a configuration other than the configuration illustrated in FIG. 5 and the like. Specifically, the light source 1 may include a first light source 1-1 used for irradiation to a predetermined effective region U0 and a second light source 1-2 located outward of the first light source 1-1 in a top view.

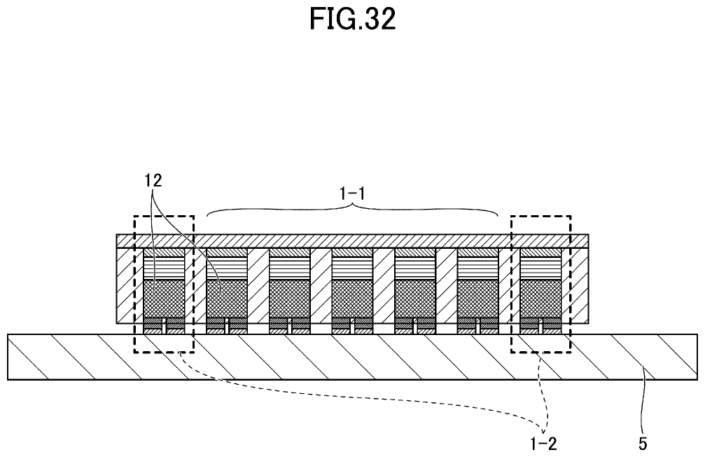

FIG. 32 is a cross-sectional view illustrating a configuration of a light source 1 including the first light sources 1-1 and the second light sources 1-2. As illustrated in FIG. 32, each of the first light source 1-1 and the second light source 1-2 includes a plurality of light-emitting elements 12. A plurality of light-emitting elements 12 included in the second light sources 1-2 are located outward of a plurality of light-emitting elements 12 included in the first light sources 1-1 in a top view. For example, in a top view, the first light sources 1-1 are disposed such that the plurality of light-emitting elements of the first light sources 1-1 are arranged in a matrix, and the second light sources 1-2 are disposed such that the plurality of light-emitting elements of the second light source 1-2 surround the first light source 1-1. With this configuration, individual light 210 from the second light source 1-2 is present outside the irradiation light 201 emitted by the first light source 1-1. Thus, the illuminance at the outer edge of the irradiation light 201 emitted by the first light source 1-1 is less likely to be reduced. Accordingly, the light-emitting module 100 can secure the wide effective region UG.

Instead of the light source 1 including the first light source 1-1 and the second light source 1-2, the light-emitting module 100 may be configured such that the spread angle of individual light 210 from each light-emitting element 12 included in the light source 1 may be increased. By increasing the spread angle of the individual light 210, a region where individual lights 210 overlap at the outer edge U1 of the irradiation light 201 can be increased, and thus the light-emitting module 100 can secure the wide effective region UG.

<Modifications of First Trajectory 2r>

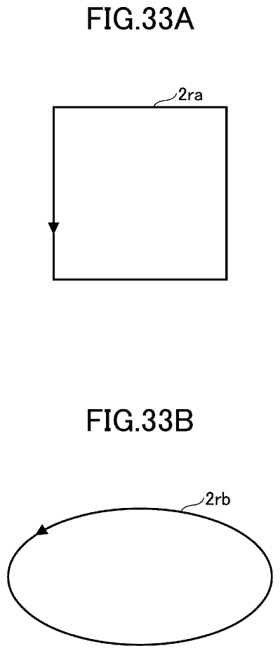

In the above-described embodiment, an example in which the first trajectory 2r has a circular shape has been described; however, the shape of the first trajectory 2r is not limited thereto and may be any one of a circular shape, a rectangular shape, or an elliptical shape. FIG. 33A and FIG. 33B are diagrams illustrating modifications of the first trajectory 2r. FIG. 33A illustrates a first trajectory 2ra having a rectangular shape. FIG. 33B illustrates a first trajectory 2rb having an elliptical shape. Alternatively, the first trajectory 2r may have a spiral shape.

However, when the lens 2 is moved such that the first trajectory 2r has a circular shape, the lens 2 can easily move at a constant speed. Therefore, from the viewpoint of easily controlling the movement of the lens 2, the first trajectory 2r preferably has a circular shape. In the first trajectory 2r, a circular shape may have a deviation of no more than ±5% of the diameter of the circular shape, and a rectangular shape may have a deviation of no more than ±5% of the length of the longest side of the rectangular shape. Further, an elliptical shape may have a deviation of no more than ±5% of the length of the major axis of the elliptical shape.

### <Main Effects of Light-Emitting Module 100>

As described above, the light-emitting module 100 includes: the light source 1 including a plurality of light-emitting elements 12; the controller 110; the lens 2; and the driver 3 configured to rotate the lens 2 such that the optical axis 2a of the lens 2 moves on the first trajectory 2r in a top view. Individual light 210 from each of the plurality of light-emitting elements 12 after being transmitted through the lens 2 (light from each of the plurality of light-emitting elements after being transmitted through the lens) is emitted such that a main light beam 2m of the individual light 210 moves on a second trajectory 210r corresponding to the first trajectory 2r. The controller 110 can change the brightness Br of the individual light 210 from each of the plurality of light-emitting elements 12 in each of divided time periods T1 to T4 obtained by dividing one cycle T into four (in each of a plurality of divided time periods obtained by dividing one cycle), where the one cycle T is defined as one round of the main light beam 2m on the second trajectory 210r.

Each of regions irradiated with individual lights 210 can be further divided by brightness produced by overlapping irradiation lights 201 in which the brightness of the individual lights 210 is changed in each of the divided time periods T1 to T4. Accordingly, the light-emitting module 100 having high spatial resolution of irradiation light 201 can be provided. By using high spatial resolution irradiation light 201, a pattern of the irradiation light 201 can be made finer, that is, the irradiation light 201 having a higher resolution pattern can be obtained. Thus, the irradiation light 201 having an irradiation light pattern along the contour of an object can be emitted. In the present embodiment, a configuration in which the driver 3 rotates the lens 2 such that the optical axis 2a of the lens 2 moves on the first trajectory 2r in a top view is exemplified; however, the configuration is not limited thereto. It is only necessary for the driver 3 to make a relative rotation between the lens 2 and the light source 1, and thus the driver 3 may rotate the light source 1 such that the central axis 1c of the light source 1 moves on the first trajectory 2r in a top view, for example. Further, the driver 3 may rotate both the lens 2 and the light source 1 such that the optical axis 2a of the lens 2 and the central axis 1c of the light source 1 move on the first trajectory 2r. With this configuration, the relative rotation speed can be increased as compared to when only either the lens 2 or the light source 1 is rotated. As a result, for example, when the time taken for one cycle of rotational movement is set to be the same between the lens 2 and the light source 1, the axes of the lens 2 and the light source 1 can move on a larger first trajectory.

Further, in the present embodiment, the controller 110 changes the brightness Br of the individual light 210 from each of the light-emitting elements 12, based on distance information Ds (object information) acquired at each of the detection point 410r-T1, the detection point 410r-T2, the detection point 410r-T3, and the detection point 410r-T4 (each of a plurality of detection points) on the second trajectory 210r. For example, there is a case that a person or the like, which is an object, is located near an imaging device and the background around the person is away from the imaging device. In such a case, if light having the same brightness is emitted to the entire region from a light-emitting module included in the imaging device, the brightness of the object would become excessive, and abnormalities such as overexposure would occur in an image captured by the imaging device. In the present embodiment, for example, an object located closer to imaging device 300 can be irradiated with darker light based on the distance information Ds. Thus, abnormalities such as overexposure in an image captured by the imaging device 300 can be suppressed. The object information is not limited to the distance information Ds, and may include at least one of distance information with respect to the object, brightness information, or image information. Further, the object information may include information acquired by referring to the memory 500. The same or similar effects can be obtained in the above cases.

Further, in the present embodiment, one cycle T is divided into four time periods during each of which the main light beam 2m passes through a corresponding one of the detection point 410r-T1, the detection point 410r-T2, the detection point 410r-T3, and the detection point 410r-T4. Accordingly, the brightness Br of the individual light 210 from each of the light-emitting elements 12 can be changed in each of the divided time periods T1 to T4 obtained by dividing one cycle T into four.

Further, in the present embodiment, for example, distance information Ds at the detection point 410r-T2 may be calculated based on distance information Ds (object information group) of pixels in a detection region Ar including the detection point 410r-T2. For example, by using all pieces of distance information Ds included in the detection region Ar, the detection accuracy of the distance information Ds can be improved.

Further, in the present embodiment, the rotation time taken for one cycle T in which the optical axis 2a of the lens 2 makes one round on the first trajectory 2r is 30 ms or less. Accordingly, when a photographer using the smartphone 1000 captures a moving image, the photographer cannot visually perceive the movement of the individual light 210 along the second trajectory 210r with the naked eyes. Thus, flickering of the individual light 210 accompanying the rotation of the lens 2 can be suppressed by an afterimage effect of human eyes. As a result, the influence on the photographer's eyes can be suppressed.

Further, in the present embodiment, the rotation time taken for one cycle T in which the optical axis 2a of the lens 2 makes one round on the first trajectory 2r is smaller than 1/(3×Te), where Te represents the exposure time of the imaging device 300. Accordingly, the effect of suppressing spots on a captured image can be obtained. The exposure time Te is preferably a natural number multiple of one cycle T. In this case, the brightness of irradiation light in each exposure time Te is likely to be constant, and thus spots can be suppressed.

Further, in the present embodiment, the brightness Br of individual light 210 from each of the plurality of light-emitting elements 12, acquired at each of the detection point 410r-T1, the detection point 410r-T2, the detection point 410r-T3, and the detection point 410r-T4 is calculated by referring to the maximum distance Xm of pieces of distance information Ds or a set reference distance Xs, the maximum brightness Bₘₐₓ of the individual light 210, and distance information Ds acquired by the object information acquisition unit 121. For example, if the maximum distance Xm of the pieces of distance information Ds is greater than the reference distance Xs, the brightness Br of the individual light 210 at each of the detection point 410r-T1, the detection point 410r-T2, the detection point 410r-T3, and the detection point 410r-T4 is defined by Formula (1) above. Alternatively, if the maximum distance Xm of the pieces of distance information Ds is less than the reference distance Xs, the brightness Br of the individual light 210 at each of the detection point 410r-T1, the detection point 410r-T2, the detection point 410r-T3, and the detection point 410r-T4 is defined by Formula (2) above. Accordingly, for example, a closer object can be irradiated with darker light based on distance information Ds, and thus abnormalities such as overexposure in an image captured by the imaging device 300 can be suppressed.

### Second Embodiment

Next, a light-emitting module according to a second embodiment will be described. The same names and reference numerals as those in the above-described embodiment and modifications denote the same or similar members, and a detailed description thereof will be omitted as appropriate. The same applies to embodiments described later. The light-emitting module according to the second embodiment differs from the light-emitting module according to the first embodiment mainly in that a specific example of a driver is illustrated.

### Example Configuration of Light-Emitting Module 100A

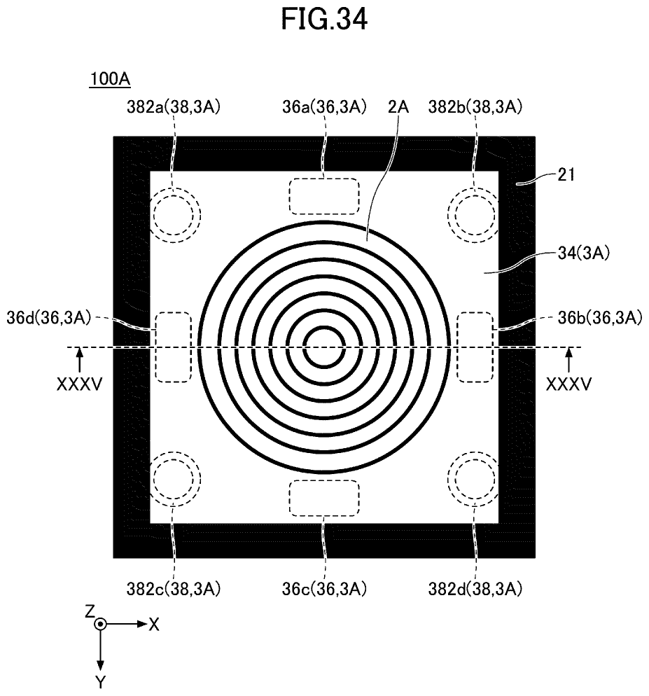

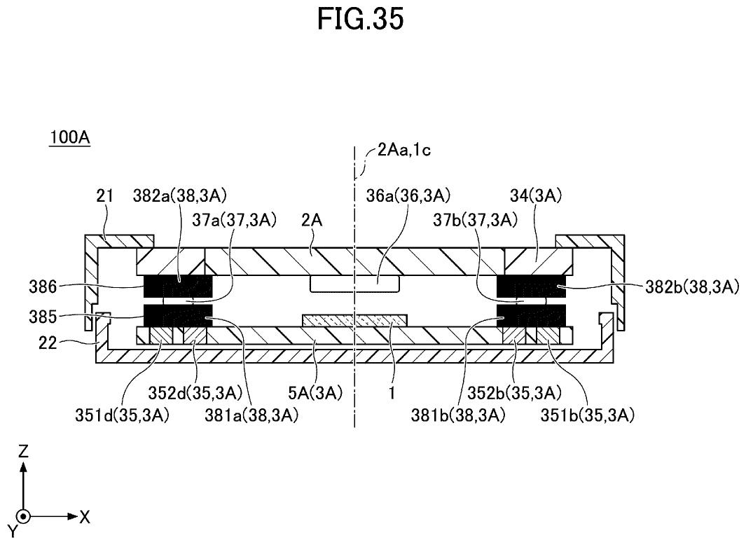

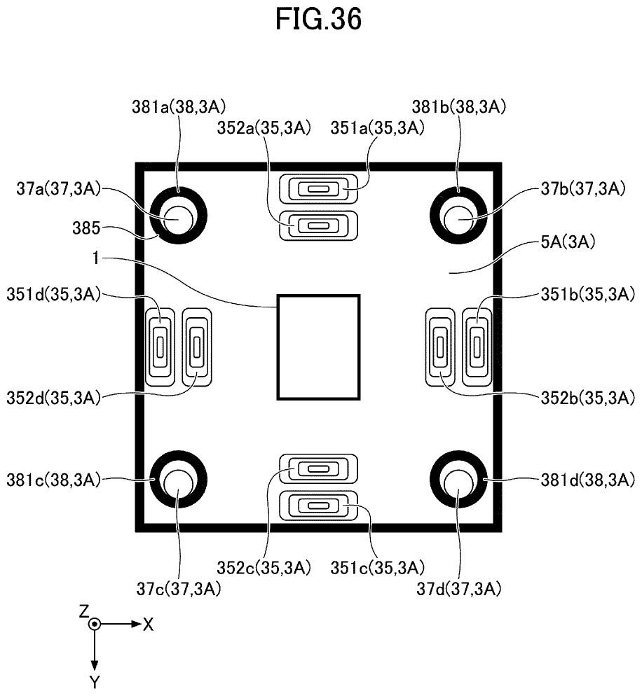

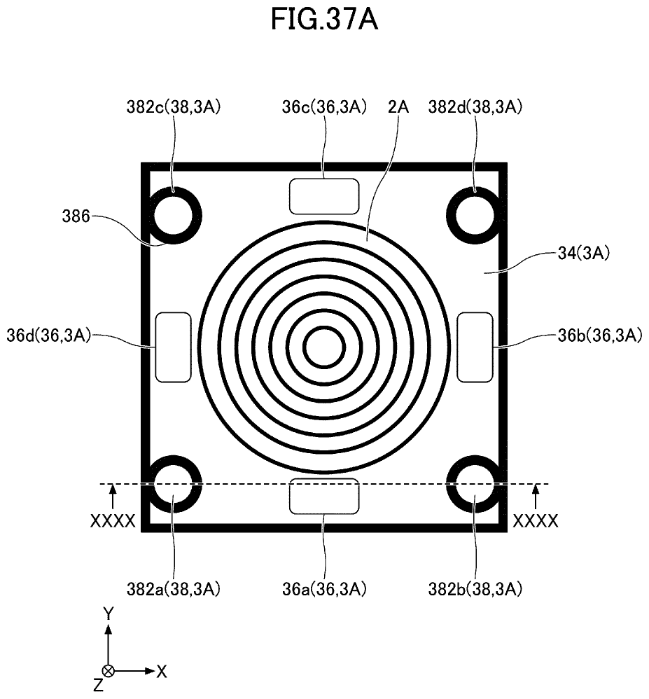

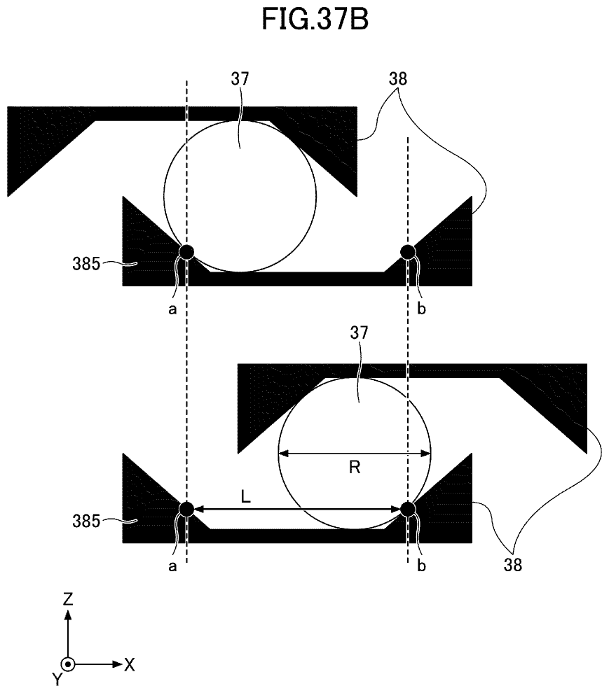

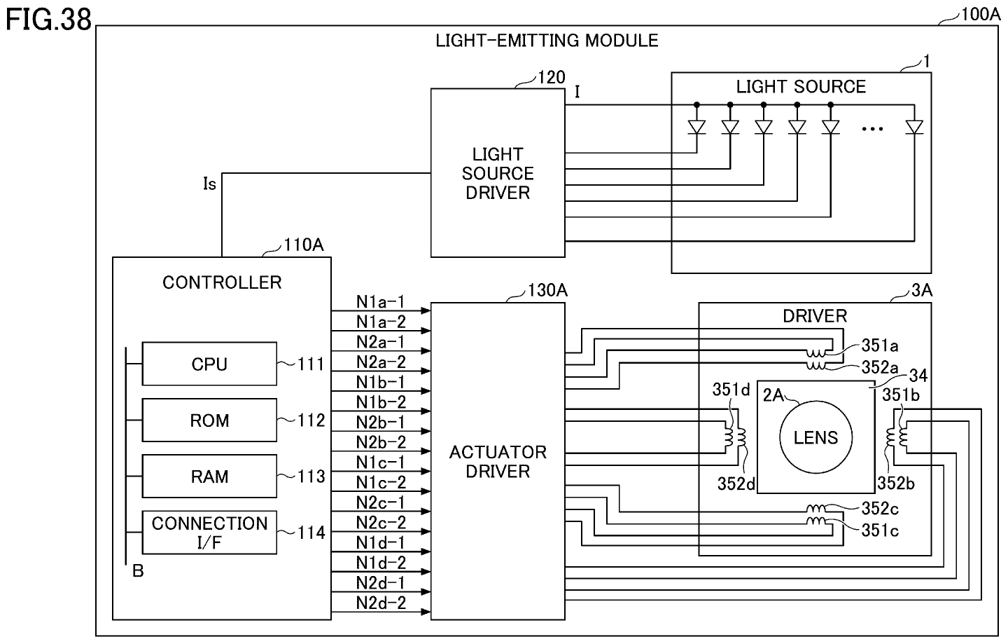

A configuration of a light-emitting module 100A according to the second embodiment will be described with reference to FIG. 34 to FIG. 38. FIG. 34 is a top view of the light-emitting module 100A. FIG. 35 is a cross-sectional view taken through the line XXXV-XXXV of FIG. 34. FIG. 36 is a plan view of a light-emitting-part mounting substrate 5A (a first fixing part) included in the light-emitting module 100A as viewed from the lens 2A side. FIG. 37A is a plan view of a movable part 34 included in the light-emitting module 100A as viewed from the light source 1 side. FIG. 37B is a diagram illustrating a preferred configuration of a rolling body and a movement restriction member included in the light-emitting module 100A. FIG. 38 is a block diagram illustrating an example of a hardware configuration of the light-emitting module 100A.

As illustrated in FIG. 34 to FIG. 38, the light-emitting module 100A includes a lens 2A, a driver 3A, a controller 110A, an actuator driver 130A, a movable-part support member 21, and a first-fixing-part support member 22, in addition to the light-emitting-part mounting substrate 5A and the movable part 34 described above. The other configurations of the light-emitting module 100A are the same as those of the light-emitting module 100 according to the first embodiment.

The lens 2A transmits light from a plurality of light-emitting elements of the light source 1. The lens 2A includes a resin material, a glass material, or the like. The lens 2A may be a Fresnel lens, a diffraction lens, or a metalens. By using a Fresnel lens, a diffraction lens, or a metalens as the lens 2A, the thickness of the light-emitting module 100A can be reduced.

The driver 3A includes the light-emitting-part mounting substrate 5A, the movable part 34, a coil 35, a magnet 36, a rolling body 37, and a movement restriction member 38. The light-emitting-part mounting substrate 5A is an example of a first fixing part on which the light source 1 is disposed. The movable part 34 is disposed facing the light-emitting-part mounting substrate 5A and holds the lens 2A. The coil 35 is disposed in the light-emitting-part mounting substrate 5A. The magnet 36 is disposed on the movable part 34. However, the coil 35 may be disposed in one of the light-emitting-part mounting substrate 5A or the movable part 34. Further, the magnet 36 may be disposed on the other one of the light-emitting-part mounting substrate 5A or the movable part 34.

The driver 3A can cause a relative rotation between the lens 2A and the light source 1 such that the central axis 1c of the light source 1 or an optical axis 2Aa of the lens 2A moves on a first trajectory having, for example, a circular shape in a top view. In the present embodiment, the light source 1 is mounted on the light-emitting-part mounting substrate 5A and does not move. The driver 3A can move the lens 2A relative to the light source 1 by moving the movable part 34 on which the lens 2A is disposed.

As illustrated in FIG. 36, the coil 35 includes a coil 351a, a coil 352a, a coil 351b, a coil 352b, a coil 351c, a coil 352c, a coil 351d, and a coil 352d. The coil 35 is disposed in the vicinity of the center of each side of the light-emitting-part mounting substrate 5A having a rectangular shape in a top view. In other words, the coil 35 is disposed outward of the light source 1.

More specifically, the coil 351a is disposed in the vicinity of the center of a side positioned on the −Y side of the light-emitting-part mounting substrate 5A. The coil 352a is disposed closer to the center of the light-emitting-part mounting substrate 5A than the coil 351a is, and is arranged next to the coil 351a. The coil 351b is disposed in the vicinity of the center of a side positioned on the +X side of the light-emitting-part mounting substrate 5A. The coil 352b is disposed closer to the center of the light-emitting-part mounting substrate 5A than the coil 351b is, and is arranged next to the coil 351b. The coil 351c is disposed in the vicinity of the center of a side positioned on the +Y side of the light-emitting-part mounting substrate 5A. The coil 352c is disposed closer to the center of the light-emitting-part mounting substrate 5A than the coil 351c is, and is arranged next to the coil 351c. The coil 351d is disposed in the vicinity of the center of a side positioned on the −X side of the light-emitting-part mounting substrate 5A. The coil 352d is disposed closer to the center of the light-emitting-part mounting substrate 5A than the coil 351d is, and is arranged next to the coil 351d.

In the present embodiment, the light-emitting-part mounting substrate 5A is a multilayer substrate in which a plurality of substrates are layered. The coil 35 has a coil structure in which conductor portions provided in the plurality of substrates are layered such that current paths thereof are continuous and function as a coil. The conductor portions formed in the plurality of substrates include a metal material or the like, and are electrically connected to each other. As the number of layered substrates increases, the number of turns of the coil 35 increases in a pseudo manner, and thus thrust for moving the movable part 34 by the driver 3A increases. The coil 35 is composed of the conductor portions formed in the plurality of substrates, and thus the thickness of the light-emitting module 100A can be reduced. The coil 35 does not have to be composed of the conductor portions formed in the plurality of substrates, and for example, a wound coil formed by winding a metal wire may be disposed on the light-emitting-part mounting substrate 5A.

As illustrated in FIG. 37A, the magnet 36 includes a magnet 36a, a magnet 36b, a magnet 36c, and a magnet 36d. The magnet 36 is disposed in the vicinity of the center of each side of the movable part 34 having a rectangular shape in a top view. In other words, the magnet 36 is disposed outward of the light source 1.

More specifically, the magnet 36a is disposed in the vicinity of the center of the side positioned on the −Y side of the movable part 34 such that the magnet 36a faces the coil 351a or the coil 352a when the light-emitting-part mounting substrate 5A and the movable part 34 are disposed facing each other. The magnet 36b is disposed in the vicinity of the center of the side positioned on the +X side of the movable part 34 such that the magnet 36b faces the coil 351b or the coil 352b when the light-emitting-part mounting substrate 5A and the movable part 34 are disposed facing each other. The magnet 36c is disposed in the vicinity of the center of the side positioned on the +Y side of the movable part 34 such that the magnet 36c faces the coil 351c or the coil 352c when the light-emitting-part mounting substrate 5A and the movable part 34 are disposed facing each other. The magnet 36d is disposed in the vicinity of the center of the side positioned on the −X side of the movable part 34 such that the magnet 36d faces the coil 351d or the coil 352d when the light-emitting-part mounting substrate 5A and the movable part 34 are disposed facing each other. The number of coils 35 and the number of magnets 36 are not limited to the numbers exemplified in the present embodiment. Each of the number of coils 35 and the number of magnets 36 is, for example, at least three. In this case, for example, coils 35 and magnets 36 may be arranged at positions corresponding to the respective vertices of an equilateral triangle having the center of gravity at the center of the light source 1 in a top view.

The magnet 36 includes a ferromagnetic material such as iron or cobalt. In the present embodiment, the magnetic pole of the magnet 36 on a side closer to the coil 35 is an N-pole. Therefore, the magnet 36 is attracted to the coil 35 whose magnetic pole on a side closer to the magnet 36 functions as an S-pole in accordance with an applied current. However, the magnetic pole of the magnet 36 on the side closer to the coil 35 is not limited to the N-pole, and may be the S-pole. The magnet 36 may be attracted to the coil 35 whose magnetic pole on the side closer to the magnet 36 functions as the N-pole in accordance with an applied current. Further, a magnetizable metal layer such as iron may be disposed on the surface of the magnet 36.

The position at which the coil 35 is disposed is not limited to the vicinity of the center of each side of the light-emitting-part mounting substrate 5A, and can be appropriately selected. The position at which the magnet 36 is disposed is not limited to the vicinity of the center of each side of the light-emitting-part mounting substrate 5A, and can be appropriately selected in accordance with the position of the coils 35.

As illustrated in FIG. 35, the rolling body 37 has, for example, a spherical shape, and is disposed between the light-emitting-part mounting substrate 5A and the movable part 34. In the present embodiment, an example in which the rolling body 37 has a spherical shape will be described. The rolling body 37 is, for example, a ball bearing including a metal material. As illustrated in FIG. 36, the rolling body 37 includes a rolling body 37a, a rolling body 37b, a rolling body 37c, and a rolling body 37d. The rolling body 37a, the rolling body 37b, the rolling body 37c, and the rolling body 37d are disposed in the vicinity of the respective corners of the light-emitting-part mounting substrate 5A. The rolling body 37 supports the movable part 34 and rolls when the movable part 34 moves, thereby facilitating the movement of the movable part 34.

The movement restriction member 38 restricts the movement of the rolling body 37 such that the rolling body 37 moves on a circular trajectory in a top view. As illustrated in FIG. 35 to FIG. 37A, the movement restriction member 38 includes a movement restriction member 381a, a movement restriction member 381b, a movement restriction member 381c, a movement restriction member 381d, a movement restriction member 382a, a movement restriction member 382b, a movement restriction member 382c, and a movement restriction member 382d. As illustrated in FIG. 36, each of the movement restriction member 381a, the movement restriction member 381b, the movement restriction member 381c, and the movement restriction member 381d has a wall portion 385 formed in an annular shape in a top view. As illustrated in FIG. 37A, each of the movement restriction member 382a, the movement restriction member 382b, the movement restriction member 382c, and the movement restriction member 382d has a wall portion 386 formed in an annular shape in a top view. The outer surface of each of the movement restriction member 381a, the movement restriction member 381b, the movement restriction member 381c, and the movement restriction member 381d may have any shape as long as the inner surface is a circular shape in a top view. For example, each of the movement restriction member 381a, the movement restriction member 381b, the movement restriction member 381c, and the movement restriction member 381d may be a rectangular parallelepiped block in which a recess having a circular shape in a top view is formed.

The movement restriction member 38 can restrict the movement of the rolling body 37 by restricting the movement of the rolling body 37 by the wall portion 385 and the wall portion 386. Further, each of the wall portion 385 and the wall portion 386 is formed in an annular shape in a top view. Thus, the movement of the rolling body 37 can be restricted such that the rolling body 37 moves on a circular trajectory. In this manner, in the light-emitting module 100A, the rolling body 37 moves along the wall portion 385 and the wall portion 386 of the movement restriction member 38. Accordingly, the movable part 34 and the lens 2A can stably move on a circular trajectory in a top view. As illustrated in FIG. 35, the inner surfaces of the wall portion 385 and the wall portion 386 of the movement restriction member 38 may be perpendicular to the bottom surface of the movement restriction member 38 or may be inclined with respect to the bottom surface of the movement restriction member 38. The rolling body 37 does not have to move along the inner surfaces of the wall portion 385 and the wall portion 386 as long as the movement of the rolling body 37 is restricted by the movement restriction member 38.

The movement restriction members 38 do not have to be disposed on both the light-emitting-part mounting substrate 5A and the movable part 34, and may be disposed on only either the light-emitting-part mounting substrate 5A or the movable part 34 as long as the movement restriction member 38 can restrict the movement of the rolling body 37. The number of movement restriction members 38 disposed on the light-emitting-part mounting substrate 5A or the movable part 34 is not limited to four and may be any number greater than or equal to three.

The position of the rolling body 37 is not limited to the corner of the light-emitting-part mounting substrate 5A, and can be appropriately selected. The position of the movement restriction member 38 is not limited to the corner of the light-emitting-part mounting substrate 5A or the movable part 34, and can be appropriately selected in accordance with the position of the rolling body 37.

As illustrated in FIG. 37B, the rolling body 37 preferably makes point contact with the inner surface of the wall portion of the movement restriction member 38. Accordingly, the contact resistance between the rolling body 37 and the movement restriction member 38 can be reduced. Further, when a point at which the inner surface of the wall portion 385 of the movement restriction member 38 contacts the rolling body 37 in a state in which the lens 2A of FIG. 37A is moved farthest in the −X direction is defined as a first contact point a as illustrated in the upper part of FIG. 37B, and the inner surface of the wall portion 385 of the movement restriction member 38 contacts the rolling body 37 in a state in which the lens 2A is moved farthest in the +X direction is defined as a second contact point b as illustrated in the lower part of FIG. 37B, a distance by which the rolling body 37 rolls from the first contact point a to the second contact point b corresponds to the diameter of the first trajectory. Further, if the rolling body 37 has a spherical shape, a diameter R of the rolling body 37 is set such that the rolling body 37 can make point contact with the first contact point a and the second contact point b. In addition, the diameter R of the rolling body 37 is preferably set to be larger than the sum of the height of the wall portion 385 and the height of the wall portion 386. Accordingly, the rolling body 37 can move in the movement restriction member 38.

The size of each movement restriction member 38 in a top view may be the same or may be different. For example, in at least one movement restriction member 38, the distance by which the rolling body 37 rolls from the first contact point a to the second contact point b can be set to correspond to the diameter of the first trajectory, and the inner diameters of the other movement restriction members 38 can be set to be large. Thus, the contact resistance between a movement restriction member 38 having a large inner diameter and the rolling body 37 in the movement restriction member 38 having the having a large inner diameter can be reduced.

The movable-part support member 21 is a member that supports the movable part 34. Specifically, the movable-part support member 21 is fixed to, for example, a housing or the like, and is provided so as to restrict the movement of the movable part 34 in the +Z direction when a force in the +Z direction acts on the movable part 34. The first-fixing-part support member 22 is a member that supports the light-emitting-part mounting substrate 5A. The movable-part support member 21 and the first-fixing-part support member 22 are not essential components of the light-emitting module 100A.

The controller 110A can control the magnetic property of the coil 35. As illustrated in FIG. 38, the controller 110A applies a current to the coil 35 through the actuator driver 130A. The controller 110A can control the magnetic property of the coil 35 by transmitting each of lens control signals N1a-1 to N2d-2 to the actuator driver 130A and controlling the direction of the applied current flowing through the coil 35. The controller 110A may control the magnetic property of the coil 35 by further controlling the amount of the applied current flowing through the coil 35.

The lens control signal N1a-1 is a signal for directing a current to flow through the coil 351a in a predetermined direction. The lens control signal N1a-2 is a signal for directing a current to flow through the coil 351a in a direction opposite to the predetermined direction. The lens control signal N2a-1 is a signal for directing a current to flow through the coil 352a in a predetermined direction. The lens control signal N2a-2 is a signal for directing a current to flow through the coil 352a in the direction opposite to the predetermined direction. The lens control signal N1b-1 is a signal for directing a current to flow through the coil 351b in a predetermined direction. The lens control signal N1b-2 is a signal for directing a current to flow through the coil 351b in the direction opposite to the predetermined direction. The lens control signal N2b-1 is a signal for directing a current to flow through the coil 352b in a predetermined direction. The lens control signal N2b-2 is a signal for directing a current to flow through the coil 352b in the direction opposite to the predetermined direction. The lens control signal N1c-1 is a signal for directing a current to flow through the coil 351c in a predetermined direction. The lens control signal N1c-2 is a signal for directing a current to flow through the coil 351c in the direction opposite to the predetermined direction. The lens control signal N2c-1 is a signal for directing a current to flow through the coil 352c in a predetermined direction. The lens control signal N2c-2 is a signal for directing a current to flow through the coil 352c in the direction opposite to the predetermined direction. The lens control signal N1d-1 is a signal for directing a current to flow through the coil 351d in a predetermined direction. The lens control signal N1d-2 is a signal for directing a current to flow through the coil 351d in the direction opposite to the predetermined direction. The lens control signal N2d-1 is a signal for directing a current to flow through the coil 352d in a predetermined direction. The lens control signal N2d-2 is a signal for directing a current to flow through the coil 352d in the direction opposite to the predetermined direction.

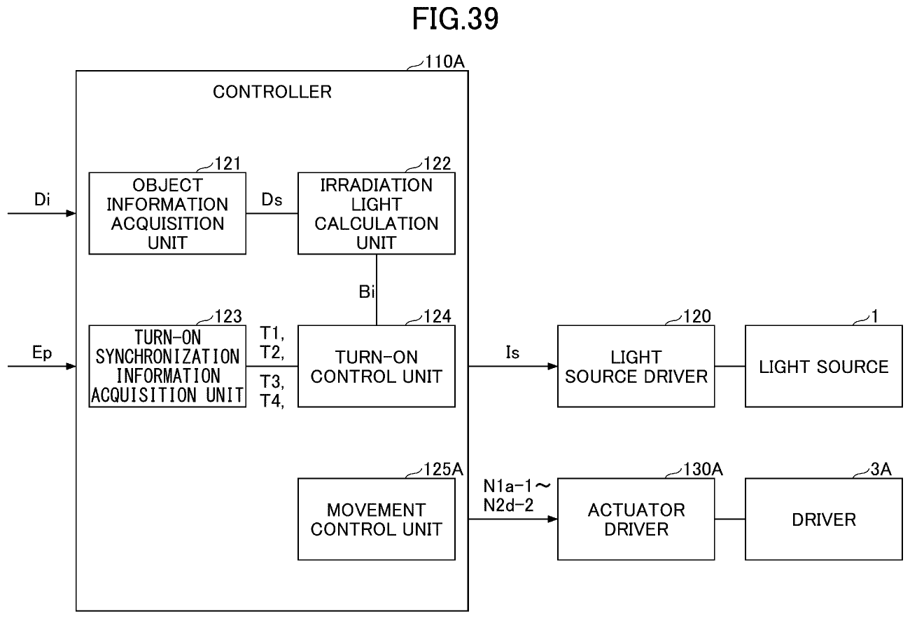

FIG. 39 is a block diagram illustrating an example of a functional configuration of the controller 110A. The controller 110A includes a movement control unit 125A. The functions of the movement control unit 125A are implemented by, for example, causing the CPU 111 of FIG. 38 to execute a predetermined program stored in the ROM 112. The movement control unit 125A transmits the lens control signals N1a-1 to N2d-2 to the actuator driver 130A. The movement control unit 125A can control the driver 3A in response to a current applied from the actuator driver 130A according to each of the lens control signals N1a-1 to N2d-2. The operation of the controller 110A is not necessarily controlled by the controller 110A. For example, the driver 3A can rotate the lens 2A or the light source 1 in response to a current applied from the actuator driver 130A at a predetermined timing.

### Example Operation of Light-Emitting Module 100A

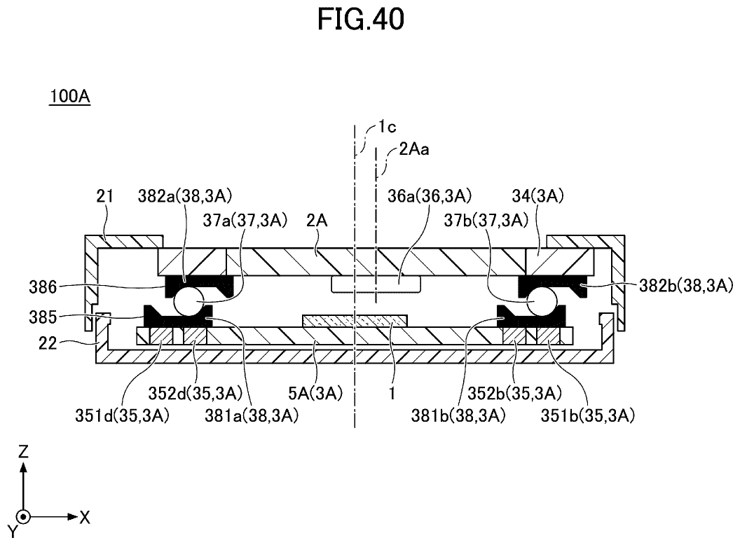

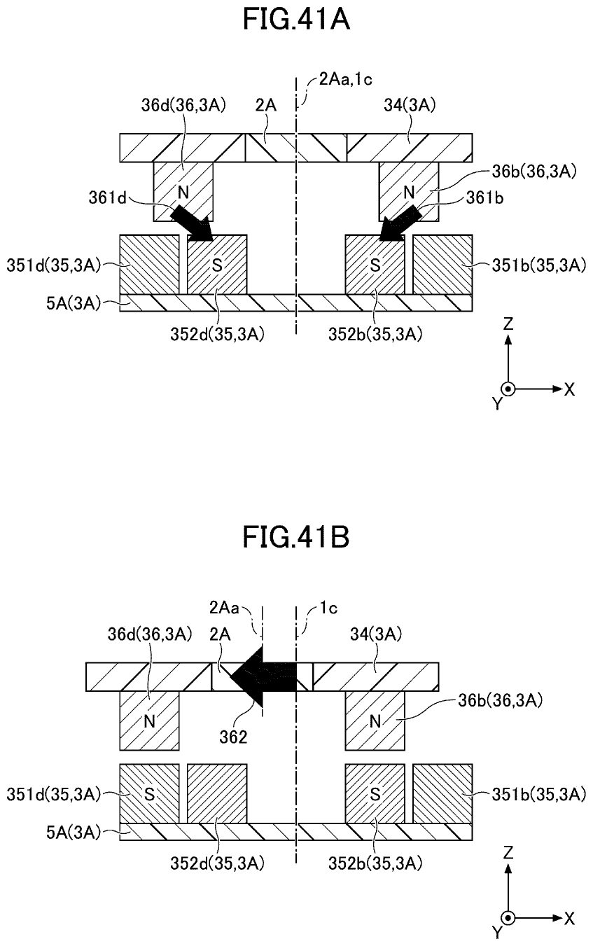

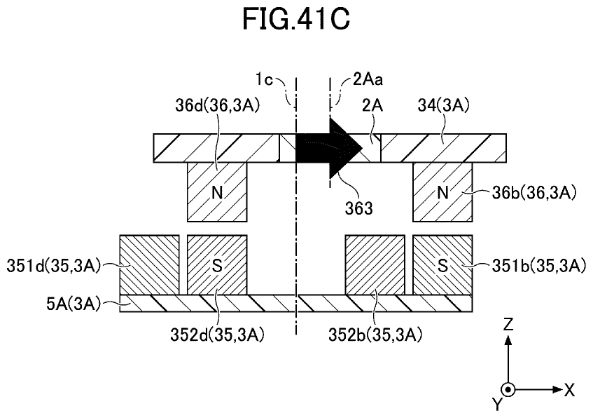

The operation of the light-emitting module 100A will be described with reference to FIG. 40, FIG. 41A, FIG. 41B, and FIG. 41C. FIG. 40 is a cross-sectional view illustrating an example of the movement of the lens 2A of the light-emitting module 100A. FIG. 41A is a schematic diagram illustrating an example of control performed by the controller 110A (see FIG. 38) to stop the lens 2A. FIG. 41B is a schematic diagram illustrating an example of control performed by the controller 110A to move the lens 2A in the −X direction. FIG. 41C is a schematic diagram illustrating an example of control performed by the controller 110A to move the lens 2A in the +X direction. Each of coils 35 and magnets 36 illustrated in FIG. 41A, FIG. 41B, and FIG. 41C are arranged such that the magnetic pole on the upper side is the N-pole or the S-pole and the magnetic pole on the lower side is the S-pole or the N-pole. In this example, only the magnetic pole on the lower side, that is, on the coil 35 side of each of the magnets 36 is illustrated, and only the magnetic pole on the upper side, that is, on the magnet 36 side of each of the coils 35 is illustrated. Further, in FIG. 40, the rolling body is illustrated such that the driving of the rolling body is easily understood. FIG. 40 illustrates a movement restriction member and the rolling body as an end view taken through the line XXXX-XXXX of FIG. 37A.

The controller 110A transmits a lens control signal to apply a current to a coil 35 such that the side of the coil 35 facing a magnet 36 functions as the S-pole, that is, functions as a magnetic pole opposite to the magnetic pole of the magnet 36 disposed on the movable part 34. The magnet 36 is attracted to the coil whose magnetic pole on the magnet 36 side functions as the S-pole, thereby moving the movable part 34. The movement of the movable part 34 causes the lens 2A to move.

FIG. 40 illustrates a state in which the movable part 34 and the lens 2A are moved in the +X direction. The rolling body 37a and the rolling body 37b roll in the +X direction according to the movement of the movable part 34 in the +X direction. Thereafter, the rolling body 37a contacts the wall portion 385 on the +X side of the movement restriction member 381a and the rolling body 37b contacts the wall portion 385 on the +X side of the movement restriction member 381b, and as a result, the movement of the rolling body 37a and the rolling body 37b in the +X direction is restricted. The wall portion 385 and the wall portion 386 are each formed in an annular shape in a top view, and thus the rolling body 37 can move on a circular trajectory along the shape of the wall portion 385 and the shape of the wall portion 386 in a top view.

As illustrated in FIG. 41A, the controller 110A controls the magnetic properties of coils 35 such that attractive forces toward the coils 35 act on magnets 36 disposed on the movable part 34 when the movable part 34 is stopped.

In FIG. 41A, the magnetic pole of the magnet 36d side of the coil 352d functions as the S-pole according to an applied current. An attractive force 361d from the coil 352d acts on the magnet 36d toward the coil 352d. The magnet 36d is attracted to the coil 352d. At this time, a current is applied to the coil 351d such that the magnetic pole on the magnet 36 side of the coil 351d functions as the N-pole. Similarly, the magnetic pole on the magnet 36 side the coil 352b functions as the S-pole in accordance with an applied current. An attractive force 361b from the coil 352b acts on the magnet 36b toward the coil 352b. The magnet 36b is attracted to the coil 352b. At this time, a current is applied to the coil 351b such that the magnetic pole on the magnet 36 side of the coil 351b functions as the N-pole.

If the magnetic forces acting on the magnet 36d and the magnet 36b are equal to each other, the magnet 36d and the magnet 36b are attracted toward the coils 35, and the attractive forces are balanced, thereby causing the movable part 34 to stop. By making an adjustment in advance such that the optical axis 2Aa of the lens 2A and the central axis 1c of the light source 1 substantially coincide with each other when the movable part 34 is stopped, the movable part 34 can be stopped in a state in which the optical axis 2Aa of the lens 2A and the central axis 1c of the light source 1 substantially coincide with each other. The controller 110A can control not only the magnetic properties of the coil 352d and the coil 352b, but also the magnetic properties of the other coils 35 arranged outward of the light source 1 in the same manner.

As illustrated in FIG. 41B, when the movable part 34 is moved in a direction indicated by an arrow 362 (in the −X direction), the magnetic poles on the magnet 36 side of the coil 351d and the coil 352b function as the S-poles according to applied currents. The magnet 36d is attracted to the coil 351d. The magnet 36b is attracted to the coil 352b. Accordingly, the movable part 34 is moved in the direction indicated by the arrow 362.

As illustrated in FIG. 41C, when the movable part 34 is moved in a direction indicated by an arrow 363 (in the +X direction), the magnetic poles on the magnet 36 side of the coil 352d and the coil 351b function as the S-poles according to applied currents. The magnet 36d is attracted to the coil 352d. The magnet 36b is attracted to the coil 351b. Accordingly, the movable part 34 is moved in the direction indicated by the arrow 363.

When the movable part 34 is moved, a current does not have to be applied to an adjacent coil, which is located adjacent to a coil to which a current is applied in a direction in which the movable part 34 is moved. Alternatively, a current may be applied to the adjacent coil located on the upstream side such that the magnetic pole on the magnet 36 side of the adjacent coil functions as the N-pole, that is, the magnetic pole on the magnet 36 side of the adjacent coil functions as the same magnetic pole as the magnetic pole on the coil 35 side of the magnet 36. When a current is applied to the adjacent coil, which is located adjacent to the coil to which a current is applied, such that the magnetic pole on the magnet 36 side of the adjacent coil functions as the N-pole, a repulsive force acts on the magnet 36 from the adjacent coil. Thus, the movement of the movable part 34 can be assisted and thrust for moving the movable part 34 can be increased.

Although an example in which the movable part 34 is moved in the X direction has been described above, the movable part 34 can be moved in the Y direction in a similar manner. Further, the movable part 34 can be moved circularly by adjusting a current applied to a coil for movement in the X direction and a current applied to a coil for movement in the Y direction.

### Third Embodiment

### Example Configuration of Light-Emitting Module 100B

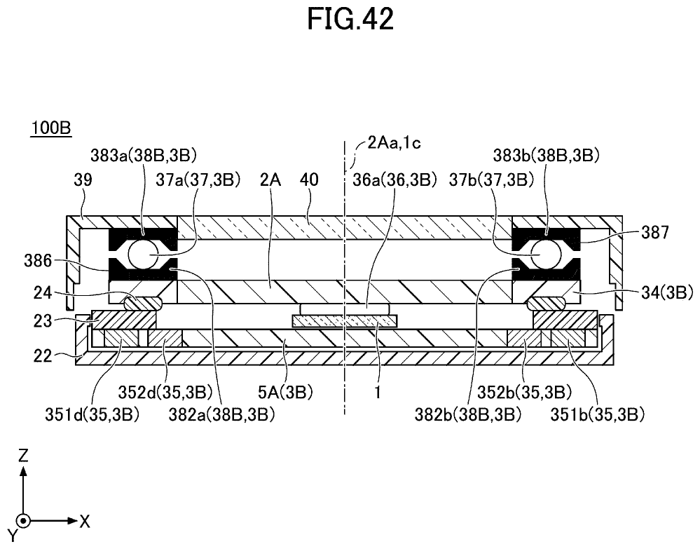

FIG. 42 is a cross-sectional view illustrating a configuration of a light-emitting module 100B according to a third embodiment. The light-emitting module 100B includes a driver 3B, a restriction part 23, and a contact part 24. The other configurations of the light-emitting module 100B are the same as or similar to those of the light-emitting module 100A according to the second embodiment. In FIG. 42, the rolling body is illustrated such that the driving of the rolling body is easily understood. FIG. 42 illustrates a movement restriction member and the rolling body as an end view taken through line corresponding to the line XXXX-XXXX of FIG. 37A.

The driver 3B includes a second fixing part 39 and a movement restriction member 38B. The second fixing part 39 is disposed facing a movable part 34. In the present embodiment, the second fixing part 39 is disposed on the side opposite to the light-emitting-part mounting substrate 5A with the movable part 34 interposed therebetween. With this configuration, the distance between the light source 1 and the lens 2A is reduced. Thus, light from the light source 1 can be efficiently condensed by the lens 2A and the light utilization efficiency of the light-emitting module 100B can be improved. Further, because the distance between the light-emitting-part mounting substrate 5A and the movable parts 34 is reduced, when coils 35 disposed in the light-emitting-part mounting substrate 5A function as electromagnets, the magnetic forces of the coils 35 can easily act on magnets 36 disposed on the movable parts 34. As a result, the movable part 34 can be moved with a small amount of power, and thus the power consumption of the light-emitting module 100B can be reduced and power saving can be achieved. However, the position of the second fixing part 39 is not limited to the above, and for example, the second fixing part 39 may be disposed between the movable part 34 and the light-emitting-part mounting substrate 5A.

The second fixing part 39 has a substantially rectangular outer shape in a top view. The material of the second fixing part 39 is not particularly limited, and a resin material, a metal material, or the like can be used. The second fixing part 39 holds an optical member 40 such that the optical member 40 faces the lens 2A disposed on the movable part 34. The optical member 40 may be any one of a light-transmissive member, a light diffusion member, a Fresnel lens, a diffraction lens, or a metalens.

The light-transmissive member according to the present embodiment means a member having a transmittance of 60% or more with respect to visible light. The light-emitting module 100B can emit light from the lens 2A through the optical member 40 by including the light-transmissive member as the optical member 40. If the second fixing part 39 is disposed on the side opposite to the light-emitting-part mounting substrate 5A with the movable part 34 interposed therebetween, the presence of the light-transmissive member allows the lens 2A not to be exposed to the outside of the light-emitting module 100B, and thus suppresses dust from adhering to the lens 2A, thereby protecting the lens 2A.

The light diffusion member according to the present embodiment is a member having the same properties as those of the light diffusion member 140 described in the first embodiment. By including the light diffusion member as the optical member 40, the light-emitting module 100B can allow light from the lens 2A to be diffused and emitted by the light diffusion member. Further, if the second fixing part 39 is disposed on the side opposite to the light-emitting-part mounting substrate 5A with the movable part 34 interposed therebetween, the presence of the light diffusion member can suppress the inside of the light-emitting module 100B from being be visually recognized from the outside. Accordingly, the aesthetic appearance of the light-emitting module 100B can be improved.

If the light-emitting module 100B includes any one of the Fresnel lens, the diffraction lens, or the metalens as the optical member 40, the number of control factors of optical design can be increased as compared to when the optical member 40 is not included. Accordingly, the degree of freedom in optical design can be improved.

The movement restriction member 38B includes a movement restriction member 383a and a movement restriction member 383b. The movement restriction member 383a and the movement restriction member 383b are disposed at the corner portions of the second fixing part 39 in a top view. The movement restriction member 383a is disposed on the lower surface (the surface on the −Z side) of the second fixing part 39 so as to face a movement restriction member 382a disposed on the upper surface (the surface on the +Z side) of the movable part 34. The movement restriction member 383b is disposed on the lower surface of the second fixing part 39 so as to face a movement restriction member 382a disposed on the upper surface of the movable part 34. The configuration and functions of the movement restriction member 38B are the same as those of the movement restriction member 38 according to the first embodiment.

The restriction part 23 and the contact part 24 are provided so as to restrict the movable part 34 from moving in the −Z direction when, for example, a force in the −Z direction is applied to the movable part 34 by a coil 35 and a magnet 36. The restriction part 23 is disposed on the upper surface (the surface on the +Z side) of the light-emitting-part mounting substrate 5A so as to extend over the entirety or a part of the sides of the light-emitting-part mounting substrate 5A. The contact part 24 is disposed on the lower surface (the surface on the −Z side) of the movable part 34 so as to extend over the entirety or a part of the sides of the movable part 34. The movement of the movable part 34 in the −Z direction is restricted by the restriction part 23 and the contact part 24.

The material of the restriction part 23 and the material of the contact part 24 are not particularly limited, and a resin material and the like can be used. The restriction part 23 and the contact part 24 are not essential components of the light-emitting module 100B.

### Example Operation of Light-Emitting Module 100B

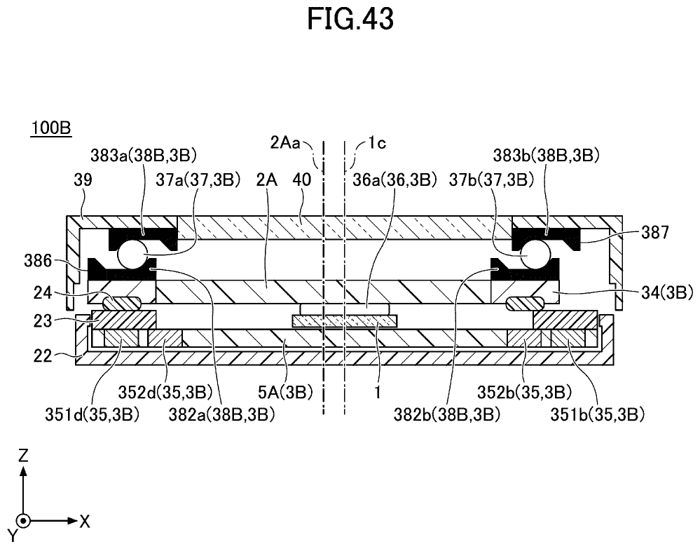

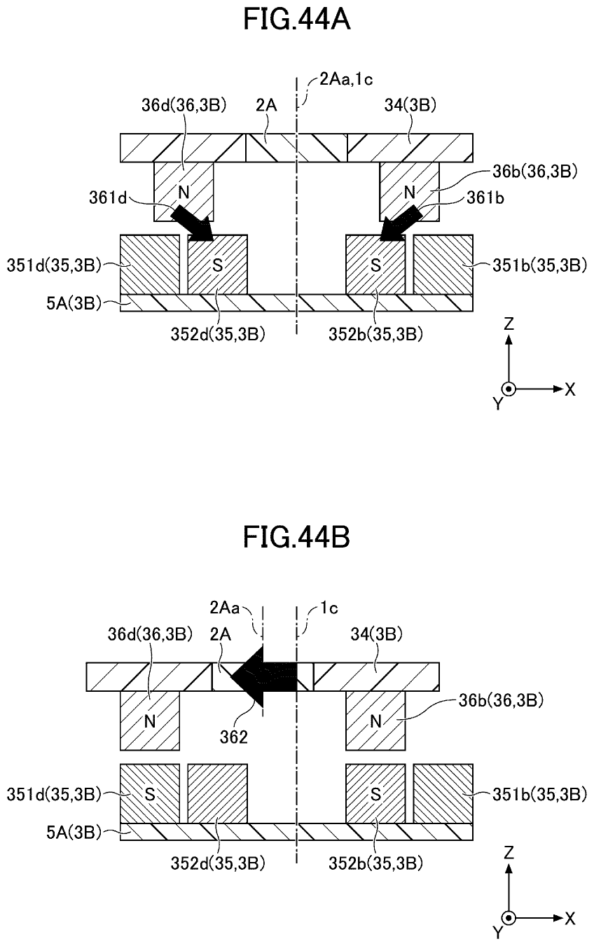

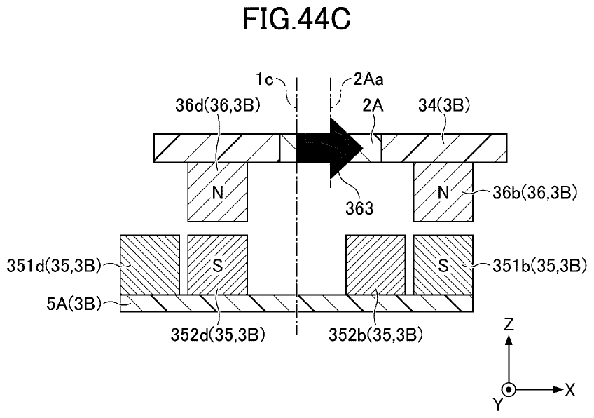

The operation of the light-emitting module 100B will be described with reference to FIG. 43, FIG. 44A, FIG. 44B, and FIG. 44C. FIG. 43 is a cross-sectional view illustrating an example of the movement of the lens 2A of the light-emitting module 100B. FIG. 44A is a schematic diagram illustrating an example of control performed by the controller 110A (see FIG. 38) to stop the lens 2A. FIG. 44B is a schematic diagram illustrating an example of control performed by the controller 110A to move the lens 2A in the −X direction. FIG. 44C is a schematic diagram illustrating an example of control performed by the controller 110A to move the lens 2A in the +X direction. The N-poles or the S-poles illustrated in FIG. 44A, FIG. 44B, and FIG. 44C illustrate the magnetic poles on the coil 35 side of magnets 36 or the magnetic poles on the magnet 36 side of coils 35, Further, in FIG. 43, the rolling body is illustrated such that the driving of the rolling body is easily understood. FIG. 43 illustrates the movement restriction member and the rolling body as an end view taken through a line corresponding to the line XXXX-XXXX of FIG. 37A.

FIG. 43 illustrates a state in which the movable part 34 and the lens 2A are moved in the −X direction. The rolling body 37a and the rolling body 37b roll in the −X direction in accordance with the movement of the movable part 34 in the −X direction. Thereafter, the rolling body 37a contacts a wall portion 387 on the −X side of the movement restriction member 383a and the rolling body 37b contacts a wall portion 387 on the −X side of the movement restriction member 383b, and as a result, the movement of the rolling body 37a and the rolling body 37b in the −X direction is restricted. The movable part 34 can be moved circularly by adjusting a current applied to a coil to be moved in the X direction and a current applied to a coil to be moved in the Y direction. The wall portion 386 and the wall portion 387 are each formed in an annular shape in a top view, and thus, when the movable part 34 is moved circularly, the rolling body 37 can move on a circular trajectory along the shape of the wall portion 386 and the shape of the wall portion 387 in a top view.

As illustrated FIG. 44A, the controller 110A controls the magnetic properties of coils 35 such that attractive forces toward the coils 35 act on magnets 36 disposed on the movable part 34 when the movable part 34 is stopped. The effects of the coils 35 according to applied currents are the same as those described with reference to FIG. 41A to FIG. 41C, and thus a duplicated description will not be repeated.

Although preferred embodiments have been described in detail above, the present disclosure is not limited to the above-described embodiments, and various modifications and substitutions can be made to the above-described embodiments without departing from the scope described in the claims. The numbers such as ordinal numbers and quantities used in the description of the embodiments are all exemplified to specifically describe the technique of the present disclosure, and the present disclosure is not limited to the exemplified numbers. In addition, the connection relationship between the components is illustrated for specifically describing the technique of the present disclosure, and the connection relationship for implementing the functions of the present disclosure is not limited thereto.

For example, a light-emitting module according to a modification of an embodiment includes a light source including a plurality of light-emitting elements; a controller configured to individually turn on the plurality of light-emitting elements, a lens configured to transmit light from the plurality of light-emitting elements, and a driver configured to drive the lens and the light source relative to each other such that an optical axis of the lens or a central axis of the light source moves on a first trajectory. Light from each of the light-emitting elements after being transmitted through the lens is emitted such that a main light beam of the light moves on a second trajectory corresponding to the first trajectory. The controller can change brightness of the light from each of the light-emitting elements in a plurality of time periods obtained by dividing one cycle, where the one cycle is defined as one round of the main light beam on the second trajectory. The controller changes the brightness of the light from each of the light-emitting elements based on object information acquired at each of a plurality of detection points on the second trajectory. The driving of the lens and the light source relative to each other in this case includes, in addition to rotational driving, oscillation or the like that is linear driving. When the lens and the light source oscillate relative to each other, for example, an effect of selectively improving the spatial resolution of irradiation light in a direction along the oscillation direction can be obtained.

The light-emitting modules according to the present disclosure can irradiate a desired partial irradiation region with light, and thus can be suitably used for lighting, camera flashes, vehicle headlights, and the like. However, the applications of the light emitting modules according to the present disclosure are not limited to these applications.

Aspects of the present disclosure are as follows, for example.

<Clause 1> A light-emitting module including: a light source including a plurality of light-emitting elements; a controller configured to individually turn on the plurality of light-emitting elements; a lens configured to transmit light from the plurality of light-emitting elements; and a driver configured to make a relative rotation between the lens and the light source such that an optical axis of the lens or a central axis of the light source moves on a first trajectory in a top view, wherein light from each of the plurality of light-emitting elements after being transmitted through the lens is emitted such that a main light beam of the light moves on a second trajectory corresponding to the first trajectory, and the controller is configured to change brightness of the light from each of the plurality of light-emitting elements in a plurality of divided time periods obtained by dividing one cycle, where the one cycle is defined as one round of the main light beam of the light on the second trajectory.

<Clause 2> The light-emitting module according to <clause 1>, wherein the controller changes the brightness of the light from each of the plurality of light-emitting elements, based on object information acquired at each of a plurality of detection points on the second trajectory.

<Clause 3> The light-emitting module according to <clause 2>, wherein the one cycle is divided into the plurality of divided time periods during each of which the main light beam of the light passes through a corresponding one of the plurality of detection points.

<Clause 4> The light-emitting module according to <clause 2> or <clause 3>, wherein the object information includes at least one of distance information with respect to an object, brightness information, or image information.

<Clause 5> The light-emitting module according to any one of <clause 2> to <clause 4>, wherein the object information includes information obtained by referring to a memory.

<Clause 6> The light-emitting module according to any one of <clause 2> to <clause 5>, wherein object information at a detection point of the plurality of detection points is calculated based on an object information group in a detection region including the detection point.

<Clause 7> The light-emitting module according to any one of <clause 1> to <clause 6>, wherein each of the first trajectory and the second trajectory has a circular shape, a rectangular shape, or an elliptical shape in the top view.

<Clause 8> The light-emitting module according to any one of <clause 1> to <clause 7>, wherein each of the first trajectory and the second trajectory has a circular shape in the top view.

<Clause 9> The light-emitting module according to <clause 8>, wherein a diameter of the first trajectory is greater than 0 times and 3 times or less a distance between centers of adjacent light-emitting elements of the plurality of light-emitting elements.

<Clause 10> The light-emitting module according to any one of <clause 1> to <clause 9>, wherein the light source includes a first light source used for irradiation to a predetermined effective region and a second light source located outward of the first light source in the top view.

<Clause 11> The light-emitting module according to any one of <clause 1> to <clause 10>, wherein a rotation time taken for the one cycle in which the optical axis of the lens makes the one round on the first trajectory is 30 ms or less.

<Clause 12> An imaging device including the light-emitting module of any one of <clause 1> to <clause 10>, wherein a rotation time taken for the one cycle in which the optical axis of the lens makes the one round on the first trajectory is less than Te/3, where Te represents an exposure time of the imaging device.

<Clause 13> An imaging device including the light-emitting module of any one of <clause 1> to <clause 10>, wherein Te is a natural number multiple of T, where Te represents an exposure time of the imaging device and T represents a rotation time taken for the one cycle in which the optical axis of the lens makes the one round on the first trajectory.

<Clause 14> An irradiation method using the light-emitting module of any one of <clause 2> to <clause 11> for irradiation of an object, the irradiation method including: an object information acquisition step for acquiring the object information at each of the plurality of detection points on the second trajectory; an irradiation light calculation step for calculating brightness of light from a light-emitting element of the plurality of light-emitting elements in each of the plurality of divided time periods, based on the object information at each of the plurality of detection points; and an irradiation step for causing the light-emitting element of the plurality of light-emitting elements to emit the light corresponding to the brightness, calculated in the irradiation light calculation step, in each of the plurality of divided time periods in a state in which the lens is rotated such that the optical axis of the lens moves on the first trajectory.

<Clause 15> The irradiation method using the light-emitting module of <clause 14>, wherein the object information is distance information, and in the irradiation light calculation step, the brightness of the light from the light-emitting element in each of the plurality of divided time periods is calculated by referring to a maximum distance of pieces of distance information or a set reference distance, maximum brightness of the light-emitting element, and distance information acquired in the object information acquisition step.

<Clause 16> The irradiation method using the light-emitting module of <clause 15>, wherein, in a case in which a maximum distance Xm of pieces of distance information, including distance information Ds acquired in the object information acquisition step, is greater than a reference distance Xs, brightness Br of the light from the light-emitting element in each of the plurality of divided time periods is defined as Br=Bₘₐₓ×Ds²/Xs², where Bₘₐₓ represents the maximum brightness of the light-emitting element.

<Clause 17> The irradiation method using the light-emitting module of <clause 15>, wherein, in a case in which a maximum distance Xm of pieces of distance information, including distance information Ds acquired in the object information acquisition step, is smaller than a reference distance Xs, brightness Br of the light from the light-emitting element in each of the plurality of divided time periods is defined as Br=Bₘₐₓ×Ds²/Xm², where Bₘₐₓ represents the maximum brightness of the light-emitting element.

<Clause 18> A light-emitting module including: a light source including a plurality of light-emitting elements; a controller configured to individually turn on the plurality of light-emitting elements; a lens configured to transmit light from the plurality of light-emitting elements; and a driver configured to drive the lens and the light source relative to each other such that an optical axis of the lens or a central axis of the light source moves on a first trajectory in a top view, wherein light from each of the plurality of light-emitting elements after being transmitted through the lens is emitted such that a main light beam of the light moves on a second trajectory corresponding to the first trajectory, the controller is configured to change brightness of the light from each of the plurality of light-emitting elements in a plurality of divided time periods obtained by dividing one cycle, where the one cycle is defined as one round of the main light beam of the light on the second trajectory, and the controller changes the brightness of the light from each of the plurality of light-emitting elements, based on object information acquired at each of a plurality of detection points on the second trajectory.

<Clause 19> The light-emitting module according to any one of <clause 1> to <clause 11>, wherein the driver includes a first fixing part on which the light source is disposed, a movable part disposed facing the first fixing part and configured to hold the lens, a coil disposed in one of the first fixing part or the movable part, a magnet disposed on another one of the first fixing part or the movable part, a rolling body disposed between the first fixing part and the movable part, and a movement restriction member configured to restrict movement of the rolling body such that the rolling body moves on the first trajectory in the top view.

<Clause 20> The light-emitting module according to any one of <clause 1> to <clause 11>, wherein the lens is a Fresnel lens, a diffraction lens, or a metalens.

<Clause 21> The light-emitting module according to <clause 19> or <clause 20>, wherein the magnet and the coil are disposed outward of the light source, and the controller controls a magnetic property of the coil such that an attractive force toward the coil acts on the magnet disposed on the movable part when the movable part is stopped.

<Clause 22> The light-emitting module according to any one of <clause 1> to <clause 11>, wherein the driver includes a first fixing part on which the light source is disposed, a movable part disposed facing the first fixing part and configured to hold the lens, a coil disposed in one of the first fixing part or the movable part, a magnet disposed on another one of the first fixing part or the movable part, a rolling body disposed between the first fixing part and the movable part, a movement restriction member configured to restrict movement of the rolling body such that the rolling body moves on the first trajectory in the top view, and a second fixing part disposed facing the movable part and configured to hold an optical member such that the optical member faces the lens disposed on the movable part.

<Clause 23> The light-emitting module according to <clause 22>, wherein the optical member is a light-transmissive member, a light diffusion member, a Fresnel lens, a diffraction lens, or a metalens.

<Clause 24> The light-emitting module according to <clause 22> or <clause 23>, wherein the second fixing part is disposed on a side opposite to the first fixing part with the movable part interposed therebetween.

This application is based on and claims priority to Japanese Patent Application No. 2022-054905, filed on Mar. 30, 2022, and Japanese Patent Application No. 2022-151309, filed on Sep. 22, 2022, the entire contents of which are incorporated herein by reference.

### DESCRIPTION OF THE REFERENCE NUMERALS

1 light source
1-1 first light source
1-2 second light source
1c central axis
2, 2A lens
2a, 2Aa optical axis
2m main light beam
2r, 2ra, 2rb first trajectory
2r-T first trajectory irradiation point
3, 3A, 3B driver
5 light-emitting-part mounting substrate
10, 10a light-emitting part
11, 11a light-emitting surface
12 light-emitting element
13 electrode
126 wavelength conversion member
14 light diffusion member
140, 140a light diffusion member
15 covering member
21 movable-part support member
22 first-fixing-part support member
23 restriction part
24 contact part
31x, 31y coil
32x, 32y position detection sensor
34 movable part
35 coil
36 magnet
361b, 361d attractive force
362, 363 arrow
37 rolling body
38, 38B movement restriction member
385, 386, 387 wall portion
39 second fixing part
40 optical member
51 wiring
52 electrically-conductive adhesive member
100 light-emitting module
110 controller
111 CPU
112 ROM
113 RAM
114 connection I/F
120 light source driver
121 object information acquisition unit
122 irradiation light calculation unit
123 turn-on synchronization information acquisition unit
124 turn-on control unit
125, 125A movement control unit
130 actuator driver
200 imaging module
201, 201-T1, 201-T2, 201-T3, 201-T4 irradiation light
201a illuminance distribution
210 individual light
210r second trajectory
210r-T1, 210r-T2, 210r-T3, 210r-T4 second trajectory irradiation point
211, 211W first object irradiation light
212, 212W second object irradiation light
213, 213W background irradiation light
220 irradiation region
221 first object
222 second object
223 background
230 individual region
300 imaging device
301, 302 graph curve
400 LiDAR device
410r-T1, 410r-T2, 410r-T3, 410r-T4 detection point
411 first object region
412 second object region
413 background region
500 memory
1000 smartphone
a first contact point
Ar detection region
b second contact point
B system bus
Br, Br1, Br2 brightness
Bₘₐₓ maximum brightness
d distance
Di distance image
Ep exposure signal
Lp turn-on signal
I, I1, I2, I3, I4 light source drive current
Is light source control signal
L separation distance
L1, L2, L3 object distance
Mx, My lens drive current
Nx, Ny, N1a-1 to N2d-2 lens control signal
Px, Py position detection signal
R diameter
Sh, St total pixel brightness
T one cycle
T1, T2, T3, T4 divided time period
Te exposure time
Xm maximum distance
Xs reference distance
θ angle
U0 effective region
U1 outer edge

1. A light-emitting module comprising:
a light source comprising a plurality of light-emitting elements;
a controller configured to individually turn on the plurality of light-emitting elements;
a lens configured to transmit light from the plurality of light-emitting elements; and
a driver configured to cause a relative rotation between the lens and the light source such that an optical axis of the lens or a central axis of the light source moves on a first trajectory in a top view, wherein:
light from each of the plurality of light-emitting elements after being transmitted through the lens is emitted such that a main light beam of the light moves on a second trajectory corresponding to the first trajectory, and
the controller is configured to change a brightness of the light from each of the plurality of light-emitting elements in a plurality of divided time periods obtained by dividing one cycle, where the one cycle is defined as one round of the main light beam of the light on the second trajectory.

2. The light-emitting module according to claim 1, wherein:
the controller is configured to:
acquire objection information at each of a plurality of detection points on the second trajectory, and
change the brightness of the light from each of the plurality of light-emitting elements based on the acquired object information.

3. The light-emitting module according to claim 2, wherein during each of the plurality of divided time periods, the main light beam of the light passes through a corresponding one of the plurality of detection points.

4. The light-emitting module according to claim 2, wherein the object information comprises at least one of distance information with respect to an object, brightness information, or image information.

5. The light-emitting module according to claim 2, wherein the object information comprises information obtained by referring to a memory.

6. The light-emitting module according to claim 2, wherein the controller is configured to calculate the object information at a detection point of the plurality of detection points based on an object information group in a detection region including the detection point.

7. The light-emitting module according to claim 1, wherein each of the first trajectory and the second trajectory has a circular shape, a rectangular shape, or an elliptical shape in the top view.

8. The light-emitting module according to claim 1, wherein each of the first trajectory and the second trajectory has a circular shape in the top view.

9. The light-emitting module according to claim 8, wherein a diameter of the first trajectory is greater than 0 times and 3 times or less a distance between centers of adjacent first and second light-emitting elements of the plurality of light-emitting elements.

10. The light-emitting module according to claim 1, wherein the light source comprises a first light source configured to irradiate a predetermined effective region, and a second light source located outward of the first light source in the top view.

11. The light-emitting module according to claim 1, wherein a rotation time taken for the one cycle in which the optical axis of the lens makes the one round on the first trajectory is 30 ms or less.

12. An imaging device including the light-emitting module of claim 1, wherein, where Te represents an exposure time of the imaging device, a rotation time taken for the one cycle in which the optical axis of the lens makes the one round on the first trajectory is less than Te/3.

13. An imaging device including the light-emitting module of claim 1, wherein, where Te represents an exposure time of the imaging device and T represents a rotation time taken for the one cycle in which the optical axis of the lens makes the one round on the first trajectory, Te is a natural number multiple of T.

14. An irradiation method using the light-emitting module of claim 2, the irradiation method comprising:
acquiring the object information at each of the plurality of detection points on the second trajectory;
calculating a brightness of light from a light-emitting element of the plurality of light-emitting elements in each of the plurality of divided time periods, based on the object information at each of the plurality of detection points; and
causing the light-emitting element of the plurality of light-emitting elements to emit the light corresponding to the brightness calculated in the irradiation light calculation step, in each of the plurality of divided time periods in a state in which the lens is rotated such that the optical axis of the lens moves on the first trajectory.

15. The irradiation method using the light-emitting module of claim 14, wherein:
the object information is distance information, and
in the calculating of the brightness, the brightness of the light from the light-emitting element in each of the plurality of divided time periods is calculated by referring to a maximum distance of pieces of distance information or a set reference distance, maximum brightness of the light-emitting element, and distance information acquired in the acquiring of the objection information.

16. The irradiation method using the light-emitting module of claim 15, wherein, in a case in which a maximum distance Xm of the pieces of distance information, including the distance information Ds acquired in the acquiring of the objection information, is greater than the reference distance Xs, the brightness Br of the light from the light-emitting element in each of the plurality of divided time periods is defined as Br=Bₘₐₓ×Ds²/Xs², where Bₘₐₓ represents the maximum brightness of the light-emitting element.

17. The irradiation method using the light-emitting module of claim 15, wherein, in a case in which the maximum distance Xm of the pieces of distance information, including the distance information Ds acquired in the object information acquisition step, is smaller than the reference distance Xs, the brightness Br of the light from the light-emitting element in each of the plurality of divided time periods is defined as Br=Bₘₐₓ×Ds²/Xm², where Bₘₐₓ represents the maximum brightness of the light-emitting element.

18. A light-emitting module comprising:
a light source comprising a plurality of light-emitting elements;
a controller configured to individually turn on the plurality of light-emitting elements;
a lens configured to transmit light from the plurality of light-emitting elements; and
a driver configured to cause a relative movement between the lens and the light source such that an optical axis of the lens or a central axis of the light source moves on a first trajectory in a top view, wherein:
the light from each of the plurality of light-emitting elements after being transmitted through the lens is emitted such that a main light beam of the light moves on a second trajectory corresponding to the first trajectory,
the controller is configured to:
change a brightness of the light from each of the plurality of light-emitting elements in a plurality of divided time periods obtained by dividing one cycle, where the one cycle is defined as one round of the main light beam of the light on the second trajectory,
acquire objection information at each of a plurality of detection points on the second trajectory, and
change the brightness of the light from each of the plurality of light-emitting elements based on the acquired object information acquired.

19. The light-emitting module according to claim 1, wherein:
the driver comprises:
a first fixing part on which the light source is disposed,
a movable part disposed facing the first fixing part and configured to hold the lens,
a coil disposed in one of the first fixing part or the movable part,
a magnet disposed on another of the first fixing part or the movable part,
a rolling body disposed between the first fixing part and the movable part, and
a movement restriction member configured to restrict movement of the rolling body such that the rolling body moves on the first trajectory in the top view.

20. The light-emitting module according to claim 1, wherein the lens is a Fresnel lens, a diffraction lens, or a metalens.

21. The light-emitting module according to claim 19, wherein
in the top view, the magnet and the coil are disposed outward of the light source, and
the controller is configured to control a magnetic property of the coil such that an attractive force toward the coil acts on the magnet disposed on the movable part when the movable part is stopped.

22. The light-emitting module according to claim 1, wherein:
the driver comprises:
a first fixing part on which the light source is disposed,
a movable part disposed facing the first fixing part and configured to hold the lens,
a coil disposed in one of the first fixing part or the movable part,
a magnet disposed on another of the first fixing part or the movable part,
a second fixing part disposed facing the movable part and configured to hold an optical member such that the optical member faces the lens disposed on the movable part,
a rolling body disposed between the second fixing part and the movable part, and
a movement restriction member configured to restrict movement of the rolling body such that the rolling body moves on the first trajectory in the top view.

23. The light-emitting module according to claim 22, wherein the optical member is a light-transmissive member, a light diffusion member, a Fresnel lens, a diffraction lens, or a metalens.

24. The light-emitting module according to claim 22, wherein the second fixing part is disposed on a side opposite to the first fixing part with the movable part interposed therebetween.
